(19) United States
(12) Patent Application Publication
(10) Pub. No.: US 2025/0354421 A1
(43) Pub. Date: Nov. 20, 2025

(54) METHODS AND APPARATUS FOR SLIDING PANEL DOOR SEAL ADJUSTMENT AND CALIBRATION

(71) Applicant: Rite-Hite Holding Corporation, Milwaukee, WI (US)

(72) Inventors: Daniel C. Vandermillen, Dubuque, IA (US); Steven Hart Campbell, Peosta, IA (US); Ryan James Pfaff, Dubuque, IA (US); Thomas L. Jansen, Dubuque, IA (US); Michael W. Moore, Dubuque, IA (US); Patrick A. Keller, Platteville, WI (US); Quinn W. Mast, Burlington, WI (US); Ryan P. Beggs, Dubuque, IA (US)

(21) Appl. No.: 19/212,053

(22) Filed: May 19, 2025

Related U.S. Application Data
(60) Provisional application No. 63/649,232, filed on May 17, 2024.

(51) Int. Cl. E05D 15/06; E06B 3/46

(52) U.S. Cl. CPC E05D 15/0639; E05D 15/0652; E06B 3/4636; E05Y 2201/64; E05Y 2600/12; E05Y 2600/314; E05Y 2600/46; E05Y 2600/62; E05Y 2900/132

(57) ABSTRACT

Methods and apparatus for sliding panel door seal adjustment and calibration are disclosed. An example apparatus includes: a first plate including a slot through which a first threaded fastener is to connect to a door panel; a second plate to be between the first plate and a head of the first threaded fastener when the first threaded fastener is connected to the door panel; and a second threaded fastener to couple the first and second plates so that rotation of the second threaded fastener results in movement of the second plate and the connected door panel relative to the first plate.

### RELATED APPLICATION(S)

This patent claims the benefit of U.S. Provisional Patent Application No. 63/649,232, which was filed on May 17, 2024. U.S. Provisional Patent Application No. 63/649,232 is hereby incorporated herein by reference in its entirety. Priority to U.S. Provisional Patent Application No. 63/649,232 is hereby claimed.

### FIELD OF THE DISCLOSURE

This disclosure relates generally to powered doors and, more particularly, to methods and apparatus for sliding panel door seal adjustment and calibration.

### BACKGROUND

Horizontally sliding doors often include one or more door panels that are suspended by carriages or carriers that travel along an overhead track. To open and close the door, the carriers move the door panels in a generally horizontal direction in front of the opening of a doorway. The movement of the panels may be powered or manually operated.

### BRIEF DESCRIPTION OF THE DRAWINGS

FIGS. 1 and 2 show an example door system constructed in accordance with teachings disclosed herein.

FIGS. 3 and 4 show another example door system constructed in accordance with teachings disclosed herein.

FIGS. 5-8 illustrate an example implementation of the carrier shown in FIGS. 1-4.

FIGS. 9-11 illustrate another example implementation of the carrier of FIGS. 1-4.

FIGS. 12-21 illustrate an example retention block assembly to support any one of the example retention blocks shown in FIGS. 1-4.

FIG. 22 is a block diagram of an example implementation of the example control circuitry of FIGS. 1-4.

FIG. 23 is a flowchart representative of example machine readable instructions and/or example operations that may be executed, instantiated, and/or performed by example programmable circuitry to implement the control circuitry of FIG. 22.

FIG. 24 is a block diagram of an example processing platform including programmable circuitry structured to execute, instantiate, and/or perform the example machine readable instructions and/or perform the example operations of FIG. 23 to implement the control circuitry of FIG. 22.

FIG. 25 is a block diagram of an example implementation of the programmable circuitry of FIG. 24.

FIG. 26 is a block diagram of another example implementation of the programmable circuitry of FIG. 24.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

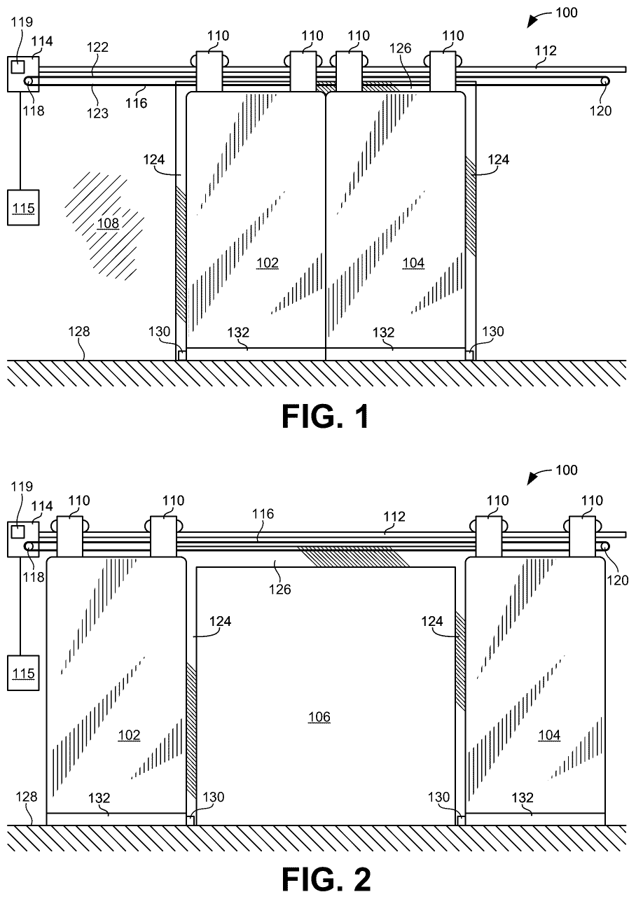

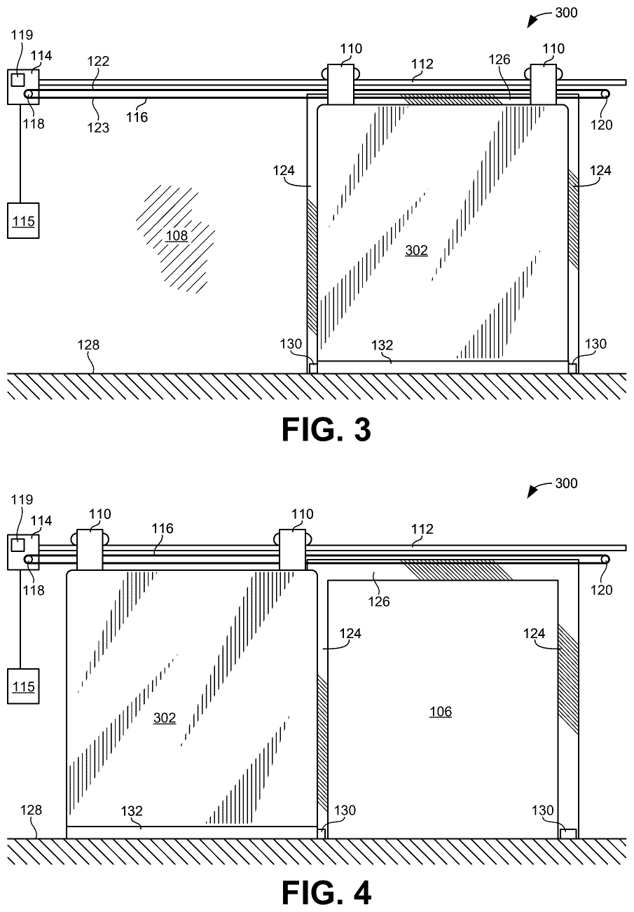

FIGS. 1-2 show an example door system 100 constructed in accordance with teachings disclosed herein. In the illustrated example of FIG. 1, the door system 100 includes two horizontally translatable (e.g., horizontally slidable) door panels 102, 104 that are in a closed position to block a doorway opening 106 in a wall 108. In the illustrated example of FIG. 2, the door panels 102, 104 are in a fully open position to unblock the doorway opening 106 (also referred to herein simply as the doorway). While the illustrated example shows two horizontally translating door panels 102, 104, teachings disclosed herein can be applied to other types and/or configurations of doors. For example, teachings of this disclosure may be applied to doors with only one panel (as shown in FIGS. 3 and 4), doors with more than two panels, and/or any other suitable type of door (e.g., a vertically translation door, a roll-up door, a foldable (e.g., bi-fold) door, a swinging door, etc.).

In some examples, the door panels 102, 104 are made of and/or contain thermally insulative materials to reduce heat transfer between areas on either side of the door system 100 (e.g., different rooms connected by the doorway opening 106). For example, the door panels 102, 104 may be made of a thermal insulating foam core encased in a protective cover. In other examples, the door panels 102, 104 may have a metal skin or outer structure that is filled with insulation. In other examples, the door panels 102, 104 may be formed of two flexible sheets with insulation pads disposed therebetween. Other panel structures and/or materials may additionally or alternatively be used.

In the illustrated example, the door panels 102, 104 are suspended from trolleys or carriers 110 that can roll, slide, or otherwise travel along an overhead track 112. In some examples, the door panels 102, 104 of the door system 100 are moved between a closed position (FIG. 1) and an open position (FIG. 2) by a drive unit 114 operated and/or controlled by control circuitry 115 in a controller communicatively coupled to the drive unit 114. In some examples, the control circuitry 115 is incorporated into and/or integrated with the drive unit 114. In some examples, the drive unit 114 includes a roller chain 116 supported between a motor-driven sprocket 118 and an idler sprocket 120. In some examples, upper and lower portions 122, 123 of the chain 116 are selectively coupled to different ones of the carriers 110 to cause the door panels 102, 104 to move between the open and closed positions as the chain 116 moves when driven by rotation of the sprocket 118. In some examples, the door system 100 may additionally or alternatively be manually operated and/or the drive unit 114 may be provided with a manual override.

In some examples, the drive unit 114 includes one or more sensor(s) 119 to monitor the operation of the door panels 102, 104 and/or the drive unit 114 and/or to provide sensor feedback data to enable the control circuitry 115 to monitor and/or control operation of the drive unit 114 and, thus, the door panels 102, 104. In some examples, the one or more sensor(s) 119 include a position sensor that monitors and/or measures the position of the door panels 102, 104 as they move between open and closed positions. In some examples, the one or more sensor(s) 119 include a torque sensor (e.g., a servo driver) that monitors and/or measures the torque generated by the drive unit 114 to move the door panels 102, 104. In some examples, the control circuitry 115 compares the measured torque values to threshold torque values to detect when a potential door fault has occurred and/or when something may be obstructing movement of the door panels 102, 104 to trigger a reversal in the direction of door movement. In some examples, the control circuitry 115 implements a calibration process to automatically configure or set the threshold torque values based on the operation of the door system 100 at the time of installation. In some examples, multiple different torque thresholds may be set for different times and/or different positions during a cycle of the door (e.g., an opening cycle, a closing cycle, etc.).

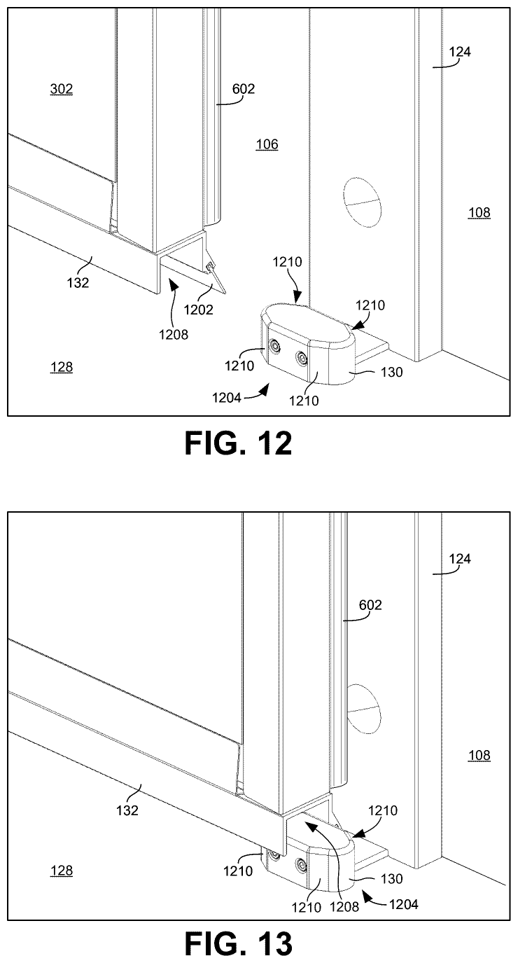

In the illustrated example, the door panels 102, 104 are spaced a distance from the wall 108 to enable their movement between opened and closed positions. As a result, there may be a gap between the door panels 102, 104 and the wall 108 when the door system 100 is closed. Accordingly, in some examples, the panels 102, 104 include and/or carry one or more wall seals (e.g., the walls seals 602 shown in FIG. 6) that protrude from the panels 102, 104 toward the wall 108 so as to interface with (e.g., engage) the wall 108, lateral door jambs 124 (e.g., side jambs), and/or a header 126 (e.g., a head jamb). In some such examples, the wall seals 602 are positioned adjacent to and/or extend along some or all of a perimeter (e.g., along the top edges and/or the outer lateral edges) of the door panels 102, 104. Such wall seals 602 serve to close off the gap between the door panels 102, 104 and the wall 108 to reduce (e.g., prevent) leakage of air between either side of the door system 100 when the door system 100 is closed. Additionally or alternatively, in some examples, the panels 102, 104 include and/or carry a bottom seal or floor seal (e.g., the floor seal 1202 shown in FIG. 12) that extends (e.g., hangs) below the bottom edge of the panels 102, 104 to interface with (e.g., engage) the floor 128. Such a floor seal 1202 serves to reduce (e.g., prevent) leakage of air underneath the door panels 102, 104 when the door system 100 is closed.

In the illustrated example, the strength of sealing engagement between the seals 602, 1202 and the structure surrounding the doorway opening 106 (e.g., the wall 108, the door jambs 124, the header 126, and the floor 128) depends upon how close the door panels 102, 104 are positioned to the surrounding structure. If the door panels 102, 104 are closer to the surrounding structure, greater sealing engagement can be achieved (for a given size of the seals 602, 1202). However, greater sealing engagement can result in greater wear on the seals 602, 1202 as they rub against the surrounding structure as the door panels 102, 104 move between the open and closed positions. As such, there is a tradeoff between strong sealing engagement and the amount of wear on the seals 602, 1202. Depending on the particular application for which the example door system 100 is put to use, sealing engagement or reducing wear may be more important. Accordingly, the example carriers 110 disclosed herein enable the position of the door panels 102, 104 to be adjusted relative to the surrounding structure in a controlled manner to selectively control how strongly the seals 602, 1202 are pressed against the surrounding structure.

More particularly, as mentioned above, in some examples, the door panels 102, 104 are suspended from the carriers 110. As such, the distance or gap between the bottom edge of the door panels 102, 104 and the floor 128 is a function of the height of the door panels 102, 104 and the height at which the carriers 110 support the door panels 102, 104 relative to the height of the track 112. In some examples, the carriers 110 are adjustable to raise or lower the door panels 102, 104 relative to the track 112. That is, the carriers 110 enable the vertical adjustment of the height of the door panels 102, 104. In this manner, the carriers 110 can be used to adjust the gap between the bottom edge of the door panels 102, 104 and the floor 128, thereby adjusting the interface or interaction between the floor seal 1202 (attached to the bottom edge of the door panels 102, 104) and the floor 128. In some examples, the distance of the panels 102, 104 from the floor 128 is different between the closed position and the open position. For instance, in some examples, the track 112 may be angled relative to the floor 128 so as to raise the panels 102, 104 farther away from the floor 128 in the open position (e.g., for less wear on the floor seal 1202) while positioning the panels 102, 104 closer to the floor 128 when the panels are in the closed position (e.g., to increase the sealing engagement between the floor seal 1202 and the floor 128).

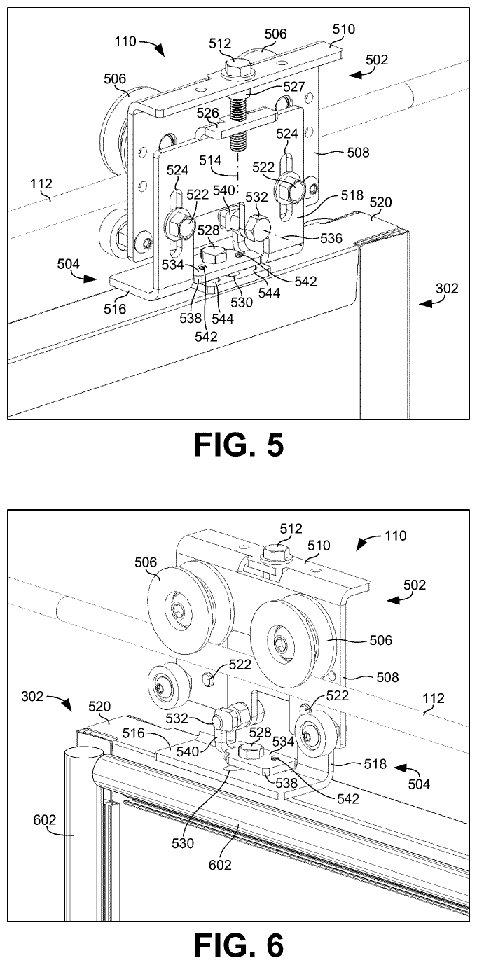

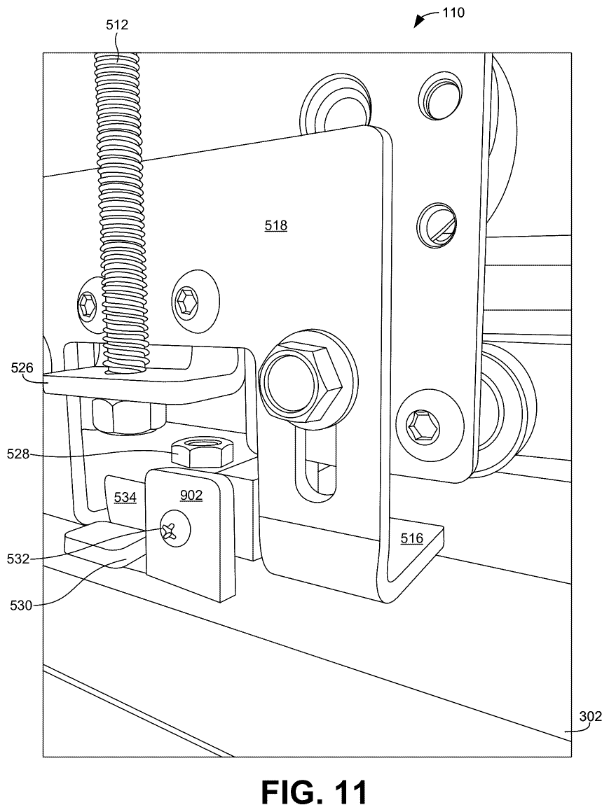

Further, in some examples, the carriers 110 are adjustable to move the door panels 102, 104 away from or towards the wall 108. That is, the carriers 110 enable the horizontal (e.g., in and out) adjustment of the height of the door panels 102, 104. In this manner, the carriers 110 can be used to adjust the spacing or gap between the door panels 102, 104 and the wall 108 (and/or the door jambs 124 and the header 126), thereby adjusting the interface or interaction between the wall seal 602 (attached to the wall-facing surface of the door panels 102, 104) and the wall 108, the door jambs 124, and/or the header 126. In some examples, the distance of the panels 102, 104 from the wall 108, the door jambs 124, and/or the header 126 is different between the closed position and the open position. For instance, in some examples, the track 112 may be angled relative to the adjacent structure (e.g., the wall 108, the door jambs 124, and/or the header 126) so move the panels 102, 104 farther away from the adjacent structure in the open position (e.g., for less wear on the wall seal 602) while positioning the panels 102, 104 closer to the adjacent structure when the panels are in the closed position (e.g., to increase the sealing engagement between the floor seal 1202 and the floor 128). Further detail regarding example implementations of the carriers 110 to enable both vertical and horizontal adjustments to the position of the door panels 102, 104 (to adjust the amount engagement of associated seals) is provided below in connection with FIGS. 5-11.

As shown in the illustrated example, the carriers 110 are attached to the top of the door panels 102, 104. Inasmuch as the door panels 102, 104 are supported from the top, it is possible for the door panels 102, 104 to sway to some extent at the bottom edge of the panels away from and/or towards the wall 108. Thus, while the carriers 110 can hold the top edge of the door panels 102, 104 at a relatively fixed distance from the wall 108, the carriers 110 cannot directly maintain the bottom edge of the door panels 102, 104 at a particular distance from the wall 108 such that there may not be proper engagement between the wall seals 602 and the wall 108 and/or door jambs 124 near the bottom of the door panels 102, 104. Accordingly, in some examples, the door system 100 includes panel retention blocks 130 to hold or retain the bottom edges of the door panels 102, 104 at a fixed distance from the wall 108 and/or the bottom of the lateral door jambs 124. More particular, in some examples, the door panels 102, 104 include a bottom track or rail 132 that engages with the corresponding panel retention blocks 130 that are positioned at a fixed distance from the wall 108 to maintain the door panels 102, 104 at that distance. In some examples, the retention blocks 130 are dimensioned and positioned to remain at least partially in engagement with a surface (e.g., a surface facing away from the doorway opening 106) of the rails 132 of the door panels 102, 104 regardless of the position of the door panels. That is, as shown in FIG. 1, when the door panels 102, 104 are in the closed position, the retention blocks 130 engage, interface with, and/or retain the door panels 102, 104 at their outer lateral edges. Further, as shown in FIG. 2, when the door panels 102, 104 are in the open position, the retention blocks 130 engage, interface with, and/or retain the door panels 102, 104 at their inner lateral edges. In some examples, the panel retention blocks 130 are adjustable to modify the distance between the retention blocks 130 and the wall 108. In this manner, the retention blocks 130 can be used to adjust the spacing or gap between the door panels 102, 104 and the wall 108 (and/or the door jambs 124) at the base of the panels, thereby adjusting the interface or interaction between the wall seal 602 and the wall 108 and/or the door jambs 124 at the base of the panels. Accordingly, the adjustment of the carriers 110 at the top of the door panels 102, 104 and the adjustment of the retention blocks 130 at the bottom of the panels 102, 104, can hold the door panels 102, 104 at any desired distance from the wall 108 to achieve any amount of sealing engagement between the wall 108 and wall seals 602 that protrude from the door panels 102, 104 toward the wall an extent at least as great as the set distance between the wall 108 and the panels 102, 104. Further detail regarding an example implementation of the retention blocks 130 to enable adjustments to the position (e.g., distance) of the door panels 102, 104 relative to the wall 108 is provided below in connection with FIGS. 12-21.

The example door system 100 of FIGS. 1 and 2 includes two separate door panels 102, 104. However, teachings disclosed herein can be suitably adapted to horizontal sliding doors having more or fewer panels. For instance, FIGS. 3 and 4 illustrate another example door system 300 that includes a single door panel 302. More particularly, FIG. 3 illustrates the example door system 300 when the door panel 302 is in a closed position and FIG. 4 illustrates the example door system 300 when the door panel 302 is in an open position. The door panel 302 of FIGS. 3 and 4 is suspended from above by similar carriers 110 as discussed above in connection with FIGS. 1 and 2 and discussed further below in connection with FIGS. 5-11. Further, as shown in the illustrated example of FIGS. 3 and 4, the bottom of the single panel 302 is retained in position by similar retention blocks 130 as discussed above in connection with FIGS. 1 and 2 and discussed further below in connection with FIGS. 12-21. However, unlike the example of FIGS. 1 and 2, the single panel 302 in FIGS. 3 and 4 is retained by two separate retention blocks 130 at each lateral edge of the panel 302 when in the closed position (FIG. 3) and remains in contact with one of the retention blocks 130 as the door panel 302 moves to the open position (FIG. 4). The door panels 102, 104 in illustrated example of FIGS. 1 and 2 are only ever retained by a single corresponding retention block 130 on either side of the doorway opening 106 so as to avoid placing any retention blocks 130 within the path through the doorway opening 106 at the middle where the inner lateral edges of the door panels 102, 104 meet. However, in other examples, the door system 100 of FIGS. 1 and 2 and/or the door system 300 of FIG. 3 may include one or more retention blocks 130 between the door jambs 124 (e.g., in the path of the doorway opening 106). Additionally or alternatively, the example door system 100 of FIGS. 1 and 2 and/or the example door system 300 of FIG. 3 may include additional retention blocks 130 positioned beyond the door jambs 124 away from the doorway opening 106 (e.g., to engage with and/or retain the door panels 102, 104, 302 when the panels 102, 104, 302 are in the open position).

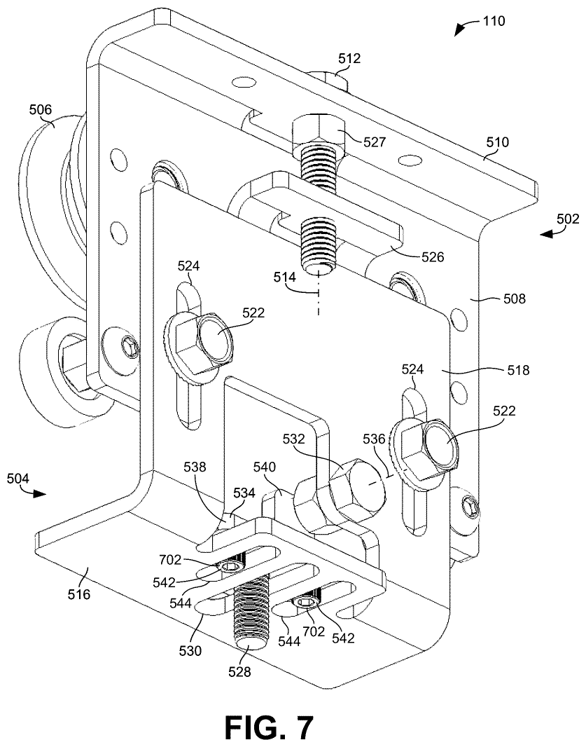

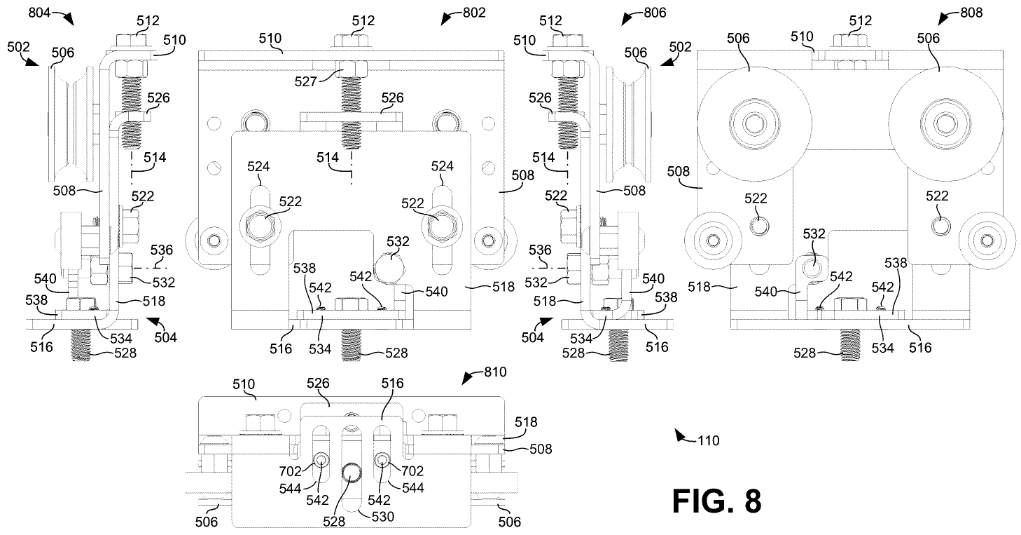

FIGS. 5-8 illustrate an example implementation of the carrier 110 shown in FIGS. 1-4. More particularly, FIG. 5 is a front, top, left perspective view of the example carrier 110 attached to the example door panel 302 of FIGS. 3 and 4; FIG. 6 is a rear, top, left perspective view of the example carrier 110 attached to the example door panel 302 of FIGS. 3 and 4; FIG. 7 is a front, bottom, left perspective view of the example carrier 110 independent of the surrounding structure (e.g., independent of the door panel 302 and the track 112); and FIG. 8 illustrates a front view 802, a left view 804, a right view 806, a rear view 808, and a bottom view 810 of the example carrier 110 independent of the surrounding structure. In the illustrated example of FIGS. 5 and 6, the door panel 302 as well as the track 112 along which the carrier 110 is to roll is shown. However, the surrounding structure used to support the track 112, as well as the wall 108, the doorway opening 106, the lateral door jambs 124, and the header 126 have been omitted for the sake of clarity. While FIGS. 5-8 are described with respect to the door panel 302 of FIGS. 3 and 4, examples disclosed herein apply equally to the door panels 102, 104 of FIGS. 1 and 2.

In the illustrated example, the carrier 110 includes a track coupling assembly 502 to couple the carrier 110 to the track 112 and a panel coupling assembly 504 to couple the carrier 110 to the door panel 302. In this example, the track coupling assembly 502 includes one or more wheels or rollers 506 that are to rest upon the track 112. In this example, there are two rollers 506, but any suitable number of rollers 506 may be employed. In the illustrated example, the rollers 506 are rotatably coupled to and supported by a first metal plate 508 of the track coupling assembly 502. In some examples, the track coupling assembly 502 includes a flange 510 (e.g., another metal plate) that includes a hole through which a first threaded fastener 512 (e.g., a bolt, a screw, etc.) may extend. In this example, the flange 510 is an integral extension of the first metal plate 508 (e.g., the first metal plate 508 and the flange 510 are provided by bending a single sheet of metal). In other examples, the flange 510 is implemented by a separate metal sheet or plate affixed to the first metal plate 508 (e.g., via welding, threaded fasteners, adhesives, press fittings, etc.). In this example, the flange 510 is substantially perpendicular to the first metal plate 508 such that an axis of rotation 514 of the first threaded fastener 512 is substantially parallel to the first metal plate 508. As used herein, substantially perpendicular means within 10 degrees of exactly perpendicular and substantially parallel means within 10 degrees of exactly parallel.

In the illustrated examples of FIGS. 5-8, the panel coupling assembly 504 includes a base plate 516 and a second metal plate 518. As shown in the illustrated example, the second metal plate 518 is coupled and extends transverse (e.g., substantially perpendicular) to the base plate 516. In this example, the base plate 516 is another metal plate that is an integral extension of the second metal plate 518 (e.g., the base plate 516 and the second metal plate 518 are provided by bending a single sheet of metal). In other examples, the base plate 516 is implemented by a separate metal sheet or plate affixed to the second metal plate 518 (e.g., via welding, threaded fasteners, adhesives, press fittings, etc.). As shown in the illustrated example, the second metal plate 518 of the panel coupling assembly 504 is to interface with and/or extend along (e.g., substantially parallel to) the first metal plate 508 of the track coupling assembly 502. Specifically, in some examples, the first metal plate 508 (of the track coupling assembly 502) is held adjacent to the second metal plate 518 (of the panel coupling assembly 504) by a plurality of threaded fasteners 522. In some examples, the threaded fasteners extend through elongate slots 524 in at least one of the first metal plate 508 or the second metal plate 518 to enable the two plates 508, 518 to be fastened at different positions relative to one another along the lengths of the elongate slots. More particularly, in this example, the elongate slots 524 are substantially parallel to the axis of rotation 514 of the first threaded fastener 512 that is threaded into a hole in a flange 526 (e.g., another metal plate) extending from the second metal plate 518 at a substantially perpendicular angle relative to the second metal plate 518 (e.g., substantially parallel to the flange 510 extending from the first metal plate 508). In this arrangement, as the first threaded fastener 512 is rotated, the panel coupling assembly 504 is raised or lowered (along the axis of rotation 514 and along the direction defined by the lengths of the elongate slots 524) relative to the track coupling assembly 502. Thus, the height of the door panel 302 and/or the associated distance from the floor 128 can be controlled to any suitable height. Once the door panel 302 is adjusted to a desired height, a nut 527 may be tightened against the flange 510 on the side opposite to the head of the first threaded fastener 512 to retain the first threaded fastener 512 in position. Further, in some examples, the additional threaded fasteners 522 may be tightened to securely fasten the panel coupling assembly 504 to the track coupling assembly 502 in fixed relationship. In this example, the flange 526 is an integral extension of the second metal plate 518 (e.g., the second metal plate 518 and the flange 526 are provided by bending a single sheet of metal). In other examples, the flange 526 is implemented by a separate metal sheet or plate affixed to the second metal plate 518 (e.g., via welding, threaded fasteners, adhesives, press fittings, etc.).

The raising or lowering of the panel coupling assembly 504 relative to the track coupling assembly 502 (via rotation of the first threaded fastener 512) enables the height of the door panel 302 to be controlled relative to the track 112 because the panel coupling assembly 504 is connected to the panel 302. More particularly, as shown in the illustrated examples of FIGS. 5 and 6, the base plate 516 of the panel coupling assembly 504 is to be adjacent to a top surface 520 of the door panel 302 and connected thereto via a second threaded fastener 528. In some examples, more than one threaded fastener is used to connect the panel coupling assembly 504 to the top surface 520 of the door panel 302. In this example, the second threaded fastener 528 connects to the door panel 302 through an elongate slot 530 (most clearly shown in FIGS. 7 and 8) in the base plate 516 of the panel coupling assembly 504. As shown in the illustrated example, the elongate slot 530 in the base plate 516 is to extend in a direction substantially perpendicular to the track 112 and to the door panel 302. In this manner, the second threaded fastener 528 can shift along the elongate slot 530 to adjust the position of the door panel 302 (connected to the fastener 528 and the fastened block) relative to the panel coupling assembly 504 and, by extension, relative to the track 112 and the wall 108. That is, the position of the door panel 302 (as well as the connected fastener 528) can be adjusted in a direction substantially perpendicular to a face (e.g., a front face or a back face) of the door panel 302.

In some examples, the position of the door panel 302 relative to the panel coupling assembly 504 is selectively controlled and/or adjusted by a third threaded fastener 532 that extends through a hole in the second metal plate 518 and is coupled to a bracket 534 disposed between a head of the second threaded fastener 528 and the base plate 516. In the illustrated example, the third threaded fastener 532 is oriented with an axis of rotation 536 that is substantially perpendicular to the second metal plate 518 and substantially parallel to the length of the elongate slot 530 such that rotation of the third threaded fastener 532 will result in the second threaded fastener 528 (and the door panel 302 connected thereto) to move along the elongate slot 530. That is, the third threaded fastener 532 functions as a set screw to set the front/back or in/out position of the door panel 302 relative to the wall 108 and the associated doorway opening 106. More particularly, the position of the door panel 302 is adjusted by rotating the third threaded fastener 532 prior to fully tightening the second threaded fastener 528. In this manner, the bracket 534 (through which the second threaded fastener 528 extends) is able to slide along the base plate 516 of the panel coupling assembly 504. In some examples, while the second threaded fastener 528 is not fully tightened, the second threaded fastener 528 is at least partially threaded into a corresponding hole in the door panel 302 such that the door panel 302 will move with the second threaded fastener 528 (and the bracket 534) relative to the base plate 516 as the third threaded fastener 532 is rotated. That is, the second threaded fastener 528 fastens the bracket 534 to the door panel 302 so that the bracket 534 and the door panel 302 move in unison relative to the base plate 516. Adjusting the position of the door panel 302 (along with the bracket 534 fastened thereto) in this manner reduces (e.g., prevents or avoids) the risk of the door panel 302 from accidentally detaching from the carrier 110 (and, by extension, the track 112) and/or falling over during initial assembly or installation as may occur for known doors that do not include the bracket 534 between the base plate 516 and the head of the second threaded fastener 528.

As shown in the illustrated example, the bracket 534 includes a plate 538 (e.g., a metal plate) with a first hole through which the second threaded fastener 528 passes to then pass through the base plate 516 and connect with the door panel 302. The example bracket 534 also includes an arm 540 (e.g., a tab) that extends upward from the plate 538 and includes a second hole to receive an end of the third threaded fastener 532. In this example, the arm 540 is an integral extension of the plate 538 (e.g., the plate 538 and the arm 540 are provided by bending a single sheet of metal). In other examples, the arm 540 is implemented by a separate metal sheet or plate affixed to the plate 538 (e.g., via welding, threaded fasteners, adhesives, press fittings, etc.). In some examples, the bracket 534 includes and/or supports one or more screws 542 (e.g., socket head cap screws) positioned adjacent to the second threaded fastener 528. In this example, the screws 542 include screw heads 702 (shown in FIGS. 7 and 8) that are positioned inside additional elongate slots 544 that extend substantially parallel to the elongate slot 530 through which the second threaded fastener 528 passes. The screw heads 702 of the screws 542 positioned within the additional elongate slots 544 serve to guide movement of the door panel 302 relative to the panel coupling assembly 504 as the third threaded fastener 532 is rotated by preventing rotation of the door panel about an axis of the second threaded fastener 528 (e.g., prior to tightening of the second threaded fastener 528). In other examples, the screw heads 702 are positioned on the same side of the plate 538 as the head of the second threaded fastener 528 and the opposite ends of the screws 542 extend into the additional elongate slots 544 (which may have a smaller dimension based on the dimension of the end of the screws 542 extending therein). In some examples, the bracket 534 can include any other type of protrusion (integrally formed or separately attached) to serve the purpose of the screws 542 that guide the movement of the bracket 534, the second threaded fastener 528, and the attached door panel 302 relative to the base plate 516 and the rest of the carrier 110. In some examples, the protrusions (e.g., the screws 542) protrude from the plate 538 of the bracket 534 a distance that is less than a thickness of the base plate 516 of the panel coupling assembly 504 so that the protrusions can glide through the corresponding slots 544 without rubbing or otherwise interacting with the top surface 520 of the door panel 302. In some examples, the additional elongate slots 544 and/or the screws 542 with their associated screw heads 702 (or other suitable protrusions) may be omitted.

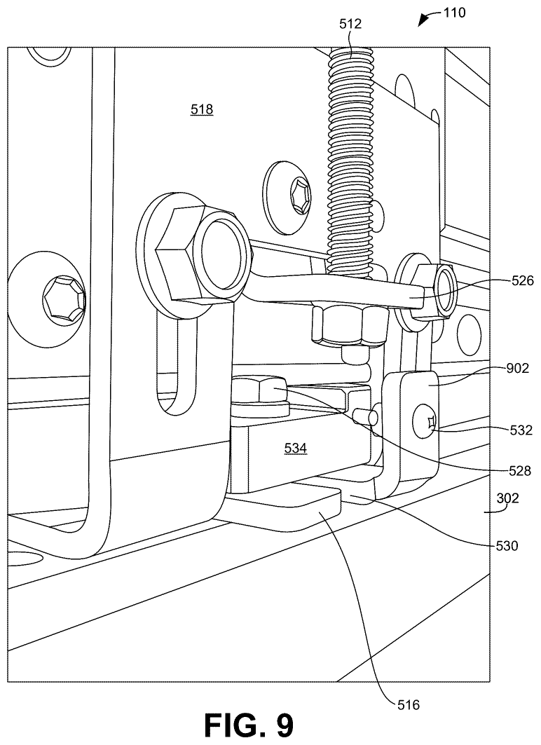

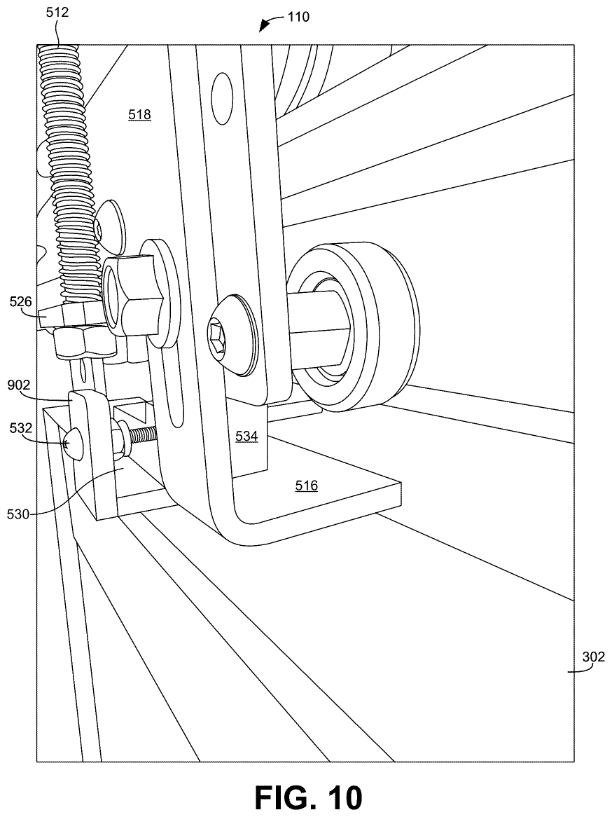

FIGS. 9-11 illustrate another example implementation of the carrier 110 of FIGS. 1-4. Similar reference numbers will be used for the same or similar parts as in the example implementation of FIGS. 5-8. As shown in the illustrated example of FIGS. 9-11, the flange 526 (into which the first threaded fastener 512 is threaded to adjust the height of the panel coupling assembly 504 relatively to the track coupling assembly 502) is at a different location relative to the second metal plate 518 from what is shown in FIGS. 5-8. Further, in FIGS. 9-11 the flange 526 is a separate piece of metal that is removably attached to the second metal plate 518 (e.g., via threaded fasteners).

Another difference between FIGS. 5-8 and FIGS. 9-11 is that the third threaded fastener 532 (e.g., a set screw used to control the in and out movement of the door panel 302) in the illustrated example FIGS. 9-11 extends through a flange 902 (e.g., a metal plate) that is offset relative the second metal plate 518. In this example, the flange 902 is an integral extension of the base plate 516. In other examples, the flange 902 can be a separate component (e.g., a distinct metal plate) coupled to the base plate 516 and/or the second metal plate 518. Further, rather than the bracket 534 (through which the second threaded fastener 528 passes before connecting to the door panel 302) including a relatively thin plate (e.g., the plate 538 of FIGS. 5-8) and an arm (e.g., the arm 540) protruding upward from the thin plate, in the illustrated example of FIGS. 9-11, the bracket 534 is a relative thick block or plate with the third threaded fastener 532 extending into a threaded hole in the side edge of the block or plate (e.g., between opposing upper and lower surfaces of the bracket 534). In some examples, the third threaded fastener 532 extends entirely through the bracket 534 (as shown in FIG. 10). Additionally, in the illustrated example, of FIGS. 9-11 the elongate slot 530 in the base plate 516 (along which the second threaded fastener 528 travels during adjustment of the third threaded fastener 532) is open at one end, rather than closed off at both ends as shown in FIGS. 5-8. In some examples, the additional elongate slots 544 (that guide the screw heads 702) can also be opened at one end. Further, in some examples, the additional elongate slots 544 and/or the screws 542 with their associated screw heads 702 may be omitted.

Different features and/or arrangements of such features are shown in the example implementation of the carrier 110 of FIGS. 5-8 relative to the example implementation of the carrier 110 of FIGS. 9-11. However, these examples are not mutually exclusive and any aspects in either of the example implementations can be used in any suitable combination.

FIGS. 12 and 13 illustrate an example retention block assembly 1204 that facilitates the anchoring or positioning of the retention blocks 130 of FIGS. 1-4 relative to the example door panel 302 of FIGS. 3 and 4. More particularly, FIG. 12 is a front, right perspective view of the example retention block assembly 1204 positioned in relationship to the example door panel 302 in a nearly closed position. FIG. 13 is a front, right perspective view of the example retention block assembly 1204 positioned in relationship to the example door panel 302 in a fully closed position. While FIGS. 12 and 13 are described with respect to the door panel 302 of FIGS. 3 and 4, examples disclosed herein apply equally to the door panels 102, 104 of FIGS. 1 and 2.

As shown in FIGS. 12 and 13, a floor seal 1202 is attached to and extends below the bottom rail 132 of the door panel so that the floor seal 1202 engages the floor 128. In some examples, the floor seal 1202 is attached to the door panel 302 independent of the bottom rail 132. How much of the floor seal 1202 engages with the floor 128 depends on the height of the door panel 302 as adjusted by the carriers 110 (e.g., by rotating the first threaded fastener 512 as shown and described in connection with FIGS. 5-11). As discussed above, in addition to controlling the height of the door panel 302, the carriers 110 at the top of the door panel 302 also control and/or facilitate adjustment of the distance (e.g., the in/out position) of the door panel 302 from the door jambs 124, the header 126, and the wall 108 (e.g., by rotating the third threaded fastener 532 as shown and described in connection with FIGS. 5-11).

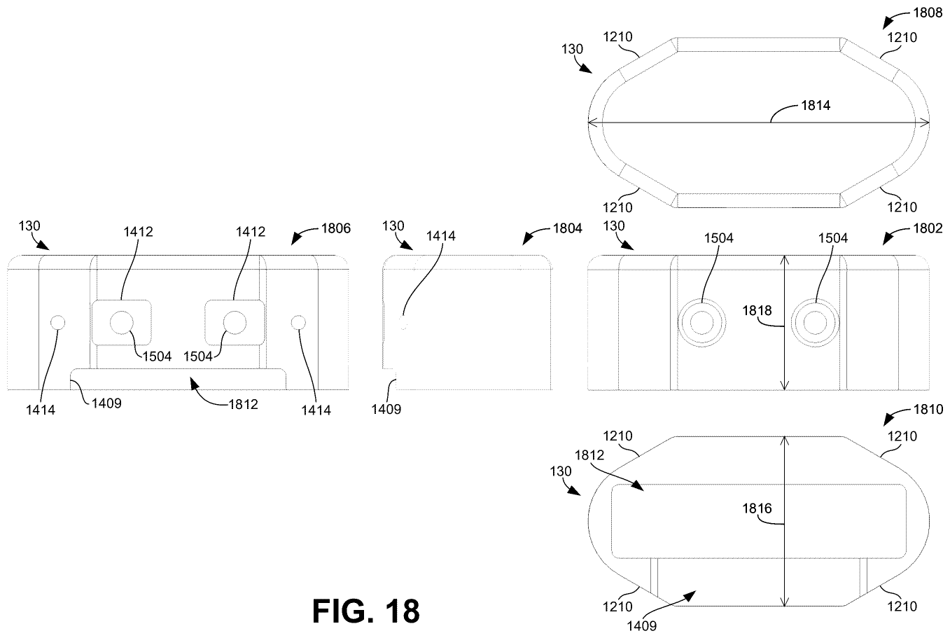

While the carriers 110 are able to retain the door panel 302 at a fixed position relative to the jambs 124, the header 126, and the wall 108 at the top of the panel 302, the panel 302 may swing or be deflected in or out relative to (e.g., away or towards) the wall 108 at the bottom of the panel 302. In some examples, such movement is reduced (e.g., minimized or avoided) by the example retention block 130 shown in FIGS. 12 and 13. Specifically, in some examples, the retention block 130 is a rigid solid body structure (e.g., metal, plastic, etc.) dimensioned with a width 1816 (FIG. 18) that fits within a channel 1208 of the bottom rail 132 on the door panel 302. When the door panel 302 is positioned so that the retention block 130 is within the channel 1208, the retention block 130 inhibits movement of the door panel 302 in a direction normal to the wall 108 because the sidewalls of the channel 1208 come into contact with the retention block 130. In some examples, the bottom rail 132 does not include an enclosed channel defined by two separate sidewalls (as shown in FIGS. 12 and 13). Instead, in some examples, the channel 1208 is open on the side of the door panel 302 facing away from the wall 108 (e.g., the bottom rail 132 is defined by an elongate plate or flange that passes between the retention block 130 and the wall 108. In such examples, the retention block 130 does not inhibit movement of the door panel 302 towards the wall 108, but still inhibits movement away from the wall 108.

In some examples, the retention block 130 is elongate with a length 1814 that is greater than the width 1816 of the retention block 130. In some examples, the length 1814 is approximately twice the width 1816. However, in other examples, the ratio of the length to width can be less than or greater than 2. In some examples, the retention has a height 1818 that is less than both the length 1814 and the width 1816 to provide vertical clearance for the retention block 130 within the channel 1208 while still being tall enough to engage with the sidewalls of the channel 1208. In some examples, the height 1818 is equal to or greater than the width 1816.

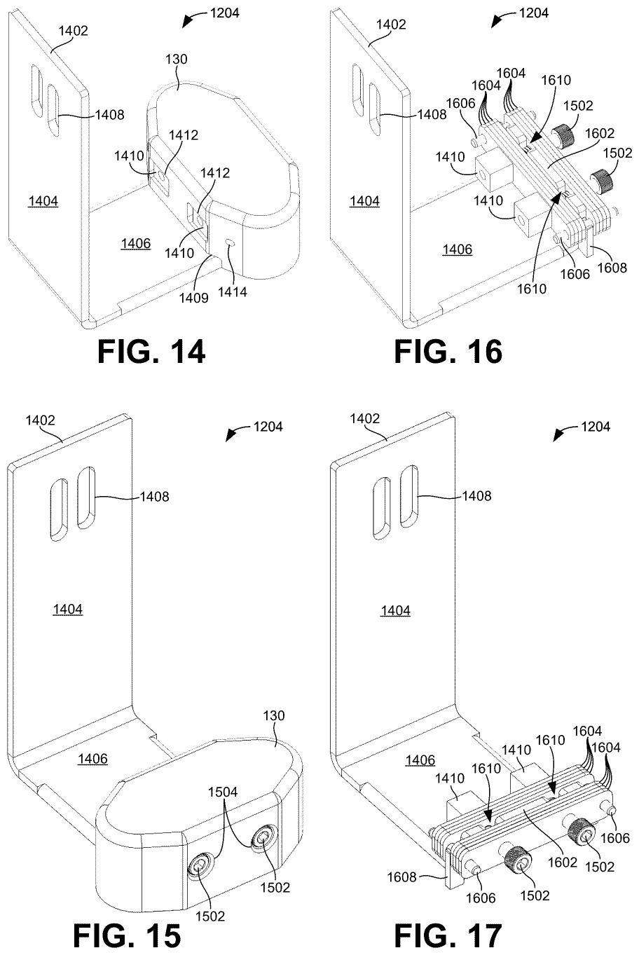

As shown in the illustrated example, the retention block 130 includes angled or tapered surfaces 1210 (shown more clearly in FIG. 18) such that the ends of the retention block 130 (along a length 1814 extending in line with the travel path of the door panel 302) are narrower than a width 1816 at a midsection of the retention block 130. In this manner, the channel 1208 of the rail does not need to be exactly aligned with the retention block 130 for the retention block 130 to catch the door panel 302 and urge it to the correct distance from the wall 108. That is, in some examples, when the door panel 302 is spaced apart from the retention block 130 (as shown in FIG. 12), the bottom of the door panel 302 may be slightly farther away from the wall 108 than when the door panel 302 is engaging the retention block 130 (as shown in FIG. 13). In some examples, the farther distance from the wall 108 when the door panel 302 is spaced apart from the retention block 130 (e.g., when the door panel 302 is moving between open and closed positions) is intentional to reduce wear on the wall seals 602 from rubbing against the wall 108 and/or the lateral door jambs 124. In some examples, this distance is set or adjusted by the carriers 110 as discussed above. In some examples, the position of the door panel 302 and the position of the retention block 130 are set so that a sidewall of the bottom rail 132 (e.g., the sidewall closest to the wall 108) will come into contact with the angled surface 1210 of the retention block 130 facing towards the wall 108 as the door panel 302 is moved to the closed position. As the door panel 302 continues to move to the fully closed position, the sidewall of the bottom rail 132 will slide against the angled surface 1210 to urge the door panel 302 towards the wall 108. As a result, the wall seal 602 on the door panel 302 is urged against the wall 108 (and/or the door jambs 124) to provide a better (e.g., stronger, tighter, etc.) sealing engagement. Additionally or alternatively, in some examples, the bottom rail 132 is angled or tapered to facilitate engagement with the retention block 130 when the door panel 302 and the retention block 130 are not exactly aligned. Further, in some examples, the door panel 302 itself may have a body that is tapered or otherwise non-uniform in thickness. In some examples, the retention block 130 engages an outer surface of the door panel 302 (e.g., an outer surface of the bottom rail 132) rather engaging an inner surface of the channel 1208. In some examples, the position of the retention block 130 can be selectively adjusted closer to or farther away from the door to increase or decrease the sealing engagement of the wall seal 602 and/or to reposition the location of the angled surfaces 1210 to catch the bottom rail. The repositioning or adjustment of the retention block 130 is described in greater detail below in connection with FIGS. 14-21.

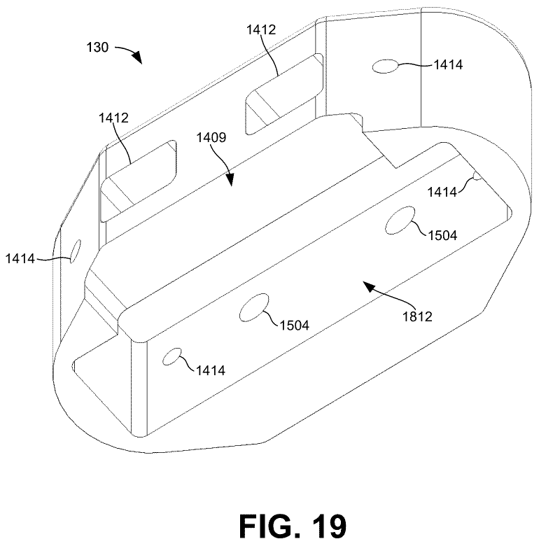

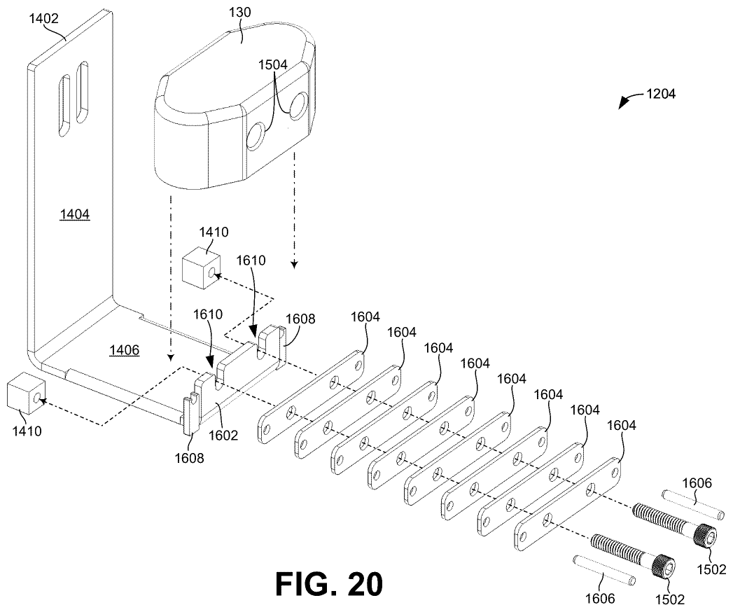

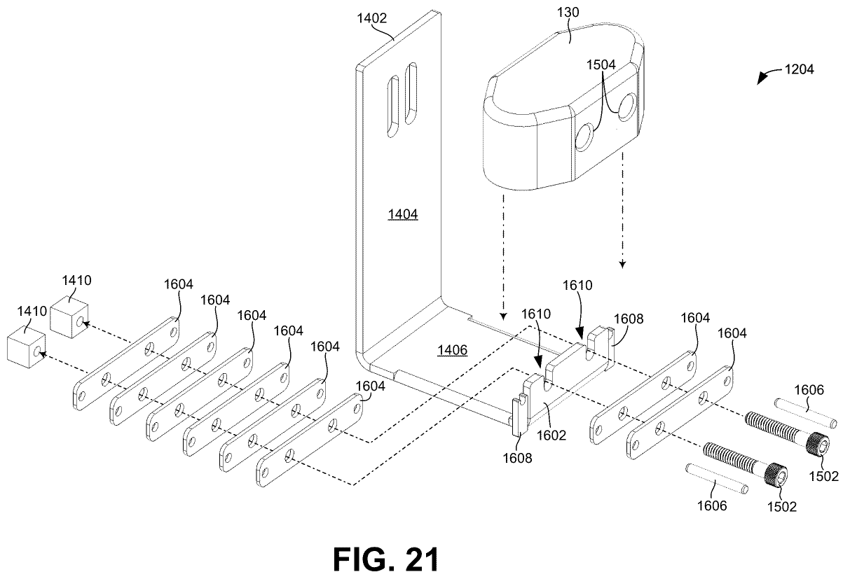

FIGS. 14-21 are detailed views of the example retention block assembly 1204 of FIGS. 12 and 13 independent of the surrounding structure (e.g., independent of the door panel 302, the door jamb 124, and the wall 108). More particularly, FIGS. 14 and 15 are respective rear, top, left and front, top, left perspective views of the example retention block assembly 1204; FIGS. 16 and 17 respectively correspond to FIGS. 14 and 15 except that the example retention block 130 is omitted, FIG. 18 illustrates a front view 1802, a left view 1804, a rear view 1806, a top view 1808, and a bottom view 1810 of the example retention block 130; FIG. 19 is a rear, left, bottom perspective view of the retention block 130; and FIGS. 20 and 21 are exploded views of the retention block assembly showing two different arrangements of example shims 1604 to adjust the position of the retention block 130.

As shown in the illustrated examples, the retention block 130 is supported by and/or held in place by an anchor plate or bracket 1402. In this example, the bracket 1402 is an L-bracket with a back plate 1404 (e.g., a metal plate), a bottom plate 1406 (e.g., a floor plate, a base plate, another metal plate), and a front flange or lip 1602 (e.g., another metal plate). In the illustrated example, the back plate 1404, the bottom plate 1406, and the front flange 1602 are integrally formed (e.g., formed by bending a single metal plate). In other examples, one or more of the back plate 1404, the bottom plate 1406, and the front flange 1602 may be separate from the others but coupled thereto in any suitable manner (e.g., via welding, threaded fasteners, adhesives, press fittings, etc.). In some examples, the bracket 1402 includes one or more holes 1408 to enable the bracket 1402 to be secured to the wall 108 and/or the door jambs 124. In the illustrated example of FIGS. 12, and 13 the bracket 1402 is attached to the wall 108 behind the door jambs 124. The bracket 1402 may have any other suitable shape and/or be attached to the surrounding structure in any other suitable manner. For instance, in some examples, the bracket 1402 is integrally formed with the door jamb 124. In some examples, the back plate 1404 is omitted and/or the holes 1408 are in the bottom plate 1406 to enable the bracket 1402 to be mounted to the floor 128.

In some examples, the front flange 1602 of the bracket 1402 enables the retention block 130 to be secured to the bracket 1402. More particularly, in some examples, the retention block 130 includes a cavity 1812 (shown in FIGS. 18 and 19) that fits over the flange 1602 of the bracket 1402 and is secured thereto by one or more threaded fasteners 1502. In some examples, the rear side of the retention block 130 includes a recess 1409 that fits over the bottom plate 1406 (as shown in FIG. 14) so that the retention block 130 reaches to the floor 128. In some examples, the cavity 1812 is dimensioned to also fit around one or more shims 1604 stacked adjacent to the flange 1602. In the illustrated example, there are eight shims 1604. However, in other examples, any other number of shims 1604 may be used (e.g., fewer or more than eight). In this examples, the shims 1604 enable adjustment of the distance of the retention block 130 relative to the back plate 1404 of the bracket 1402 and, thus, relative to the wall 108 and/or the door jamb 124. More particularly, the distance of the retention block 130 is adjusted by changing how many shims 1604 are positioned on either side of the flange 1602. For instance, in the illustrated example of FIGS. 14-16, four shims 1604 are positioned on either side of the flange 1602 such that the retention block 130 is centered over the flange 1602. By moving ones of the shims 1604 from the backside of the flange 1602 (e.g., the side facing the back plate 1404) to the front side of the flange 1602 (e.g., the side facing away from the back plate 1404), the position of the retention block 130 will incrementally shift by the thickness of the shims 1604. Thus, if all eight shims 1604 are positioned on the front side of the flange 1602 (as represented in FIG. 19), the retention block 130 will be shifted outward (e.g., away from the back plate 1404) by the thickness of four shims 1604 relative to the arrangement shown in FIGS. 14-16. Likewise, if more of the shims 1604 are positioned on the back side of the flange 1602 (as represented in FIG. 20), the position of the retention block 130 will be closer to the back plate 1404.

The overall range of positions at which the retention block 130 may be placed corresponds to the combined thickness of all of the shims 1604 and can be adjusted in increments corresponding to individual ones of the shims 1604. For instance, in some examples, each shim 1604 has a thickness of approximately 1/16 inch. As such, in the illustrated example where there are eight shims 1604, the retention block 130 can be shifted in 1/16 inch increments across a total span of ½ inch between all of the shims 1604 being on the back side of the flange 1602 and all of the shims 1604 being on the front side of the flange 1602.

In the illustrated example, the shims 1604 are secured to the flange 1602 based on compression between heads of the threaded fasteners 1502 and nuts 1410 on opposite ends of the fasteners 1502. In this example, the nuts 1410 are retained within corresponding holes 1412 on one side (e.g., the rear side) of the retention block 130 while the heads of the threaded fasteners 1502 are retained in corresponding holes 1504 on the opposite side (e.g., the front side) of the retention block 130. In some examples, the holes 1504 are counterbored holes so that a portion of the retention block 130 is retained in compression between the heads of the threaded fasteners 1502 and the shims 1604. In this manner, the retention block 130 is retained in place around the shims 1604 and the flange 1602.

In the illustrated example, to enable the threaded fasteners 1502 to connect with the nuts 1410 through the holes 1412, 1504 in the retention block 130 and also to pass through the shims 1604, the shims 1604 need to be inserted into the retention block 130 prior to extending the threaded fasteners 1502 therethrough. Accordingly, in some examples, to facilitate the alignment and/or positioning of the shims 1604 during assembly, one or more positioning pins 1606 can be inserted through holes in the shims 1604 and corresponding openings 1414 in the retention block 130. In some examples, the openings 1414 for the pins 1606 pass all the way through to an exterior of the retention block 130 on one side of the body (e.g., on the rear side in the illustrated example) but not the other. In other examples, the openings 1414 can pass entirely through the retention block 130 (e.g., from an exterior rear face to an exterior front face). In some examples, the retention block assembly 1204 includes pin braces 1608 that interface with and/or support the pins 1606 (e.g., extend from the floor 128 up to the pins 1606). In the illustrated examples, the pin braces 1608 are distinct and separate from the bracket 1402. In other examples, the pin braces 1608 may be affixed to and/or integrally formed with the bracket 1402 (e.g., affixed to and/or integrally formed with the bottom plate 1406 and/or the flange 1602). In some examples, the pin braces 1608 and/or the pins 1606 are omitted.

In the illustrated example, the threaded fasteners 1502 extend through slots 1610 that open at a top edge of the flange 1602. In this way, the threaded fasteners 1502 can be inserted into the slots 1610 after having already been inserted through the retention block 130 and the shims 1604 disposed therein (but before fully tightening the fasteners 1502 within the nuts 1410). That is, in some examples, adjustment of the position of the retention block 130 relative to the bracket 1402 includes (1) loosening the threaded fasteners 1502 sufficiently to slide the retention block 130 off of the flange 1602 of the bracket 1402 (by sliding the fasteners 1502 out from the slots 1610), (2) repositioning the number of shims 1604 within the cavity 1812 of the retention block 130 to be positioned on either side of the flange 1602 (with the threaded fasteners 1502 still extending therethrough), (3) inserting the assembly back on to the flange 1602 with the shims 1604 in their new position, and (4) retighten the threaded fasteners 1502. In some examples, the fasteners 1502 pass through holes in the flange 1602 that do not open to an edge of the flange 1602. In such examples, the shims 1604 and retention block 130 would need to be in position over the flange 1602 prior to inserting the threaded fasteners 1502. In the illustrated examples, once the retention block 130 is put into place and the threaded fasteners 1502 are tightened the retention block 130 remains in a fixed position relative to the bracket 1402 and the floor 128 with no moving parts or parts that are likely to shift over time through repeated use.

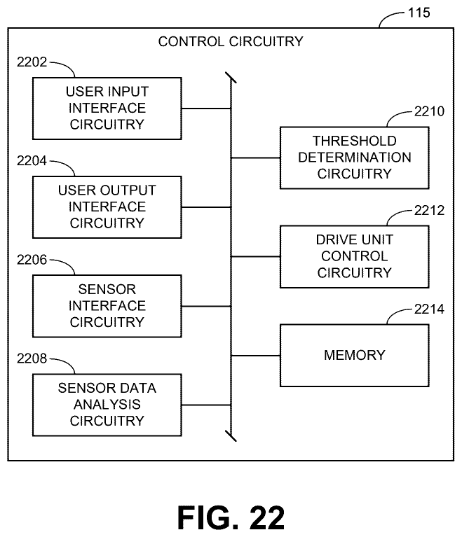

FIG. 22 is a block diagram of an example implementation of the control circuitry 115 of FIG. 1 to control operation of the drive unit 114 of FIG. 14 and, more particularly, to automatically calibrate torque thresholds associated with different zones of operation of the door systems 100, 300 of FIGS. 1-4. The example control circuitry 115 and the associated operations of the control circuitry 115 may be implemented in connection with different types of door systems other than the door systems 100, 300 shown in FIGS. 1-4. For instance, in some examples, the control circuitry 115 and the associated operations of the control circuitry 115 disclosed herein can be used to operate vertically translated doors, roll-up doors, bi-fold doors, swinging doors, and/or any other type of doors that are operated by a motor that applies a torque to move the door between open and closed positions.

As shown in the illustrated example, the control circuitry 115 includes example user input interface circuitry 2202, example user output interface circuitry 2204, example sensor interface circuitry 2206, example sensor data analysis circuitry 2208, example threshold determination circuitry 2210, example drive unit control circuitry 2212, and example memory 2214. The control circuitry 115 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the control circuitry 115 of FIG. 22 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 22 may, thus, be instantiated at the same or different times. Some or all of the circuitry of FIG. 22 may be instantiated, for example, in one or more threads executing concurrently on hardware and/or in series on hardware. Moreover, in some examples, some or all of the circuitry of FIG. 22 may be implemented by microprocessor circuitry executing instructions and/or FPGA circuitry performing operations to implement one or more virtual machines and/or containers.

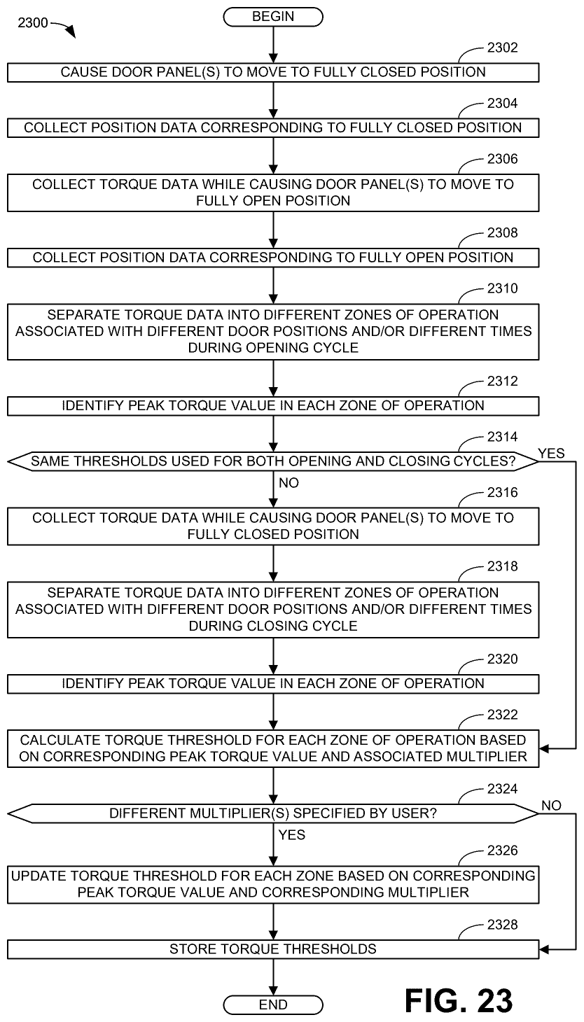

In the illustrated example of FIG. 22, the example user input interface circuitry 2202 serves to enable a user to interact with and/or provide inputs to the control circuitry 115. In some examples, the user input interface circuitry 2202 is communicatively coupled to physical buttons on a housing of the control circuitry 115 by which a user provides inputs. Additionally or alternatively, in some examples, the user input interface circuitry 2202 is communicatively coupled to a touchscreen by which a user provides inputs. Additionally or alternatively, in some examples, the user input interface circuitry 2202 enables wireless communication with a remote device by which a user provides inputs. In some examples, the user input interface circuitry 2202 is instantiated by programmable circuitry executing user input interface instructions and/or configured to perform operations such as those represented by the flowchart(s) of FIG. 23.

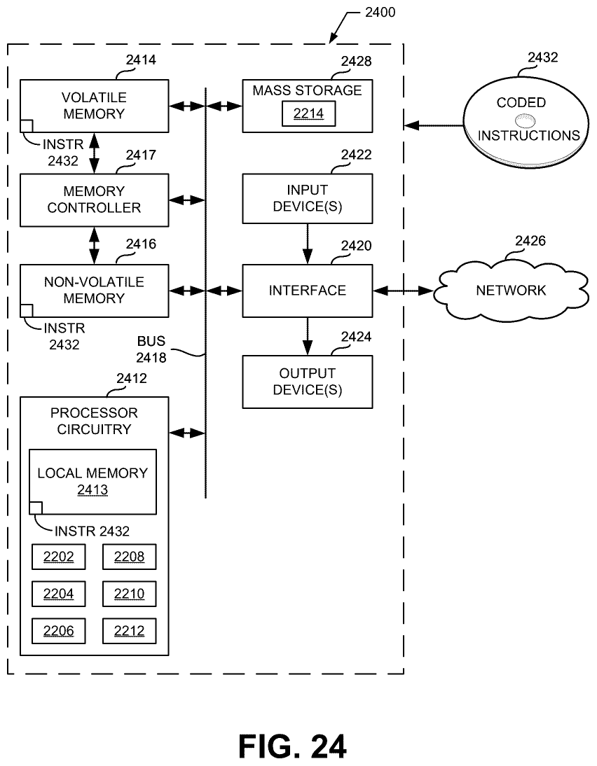

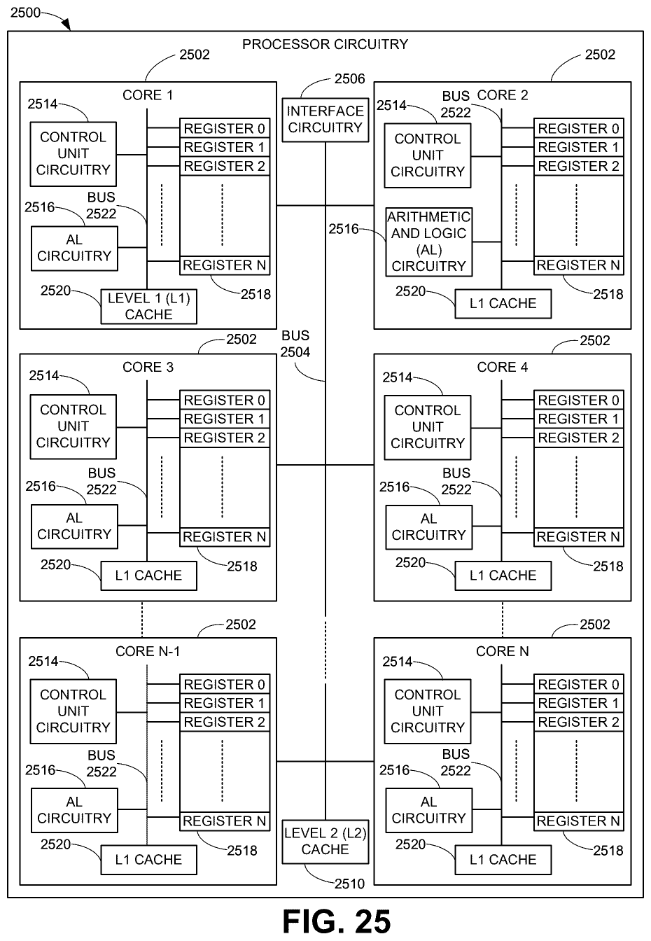

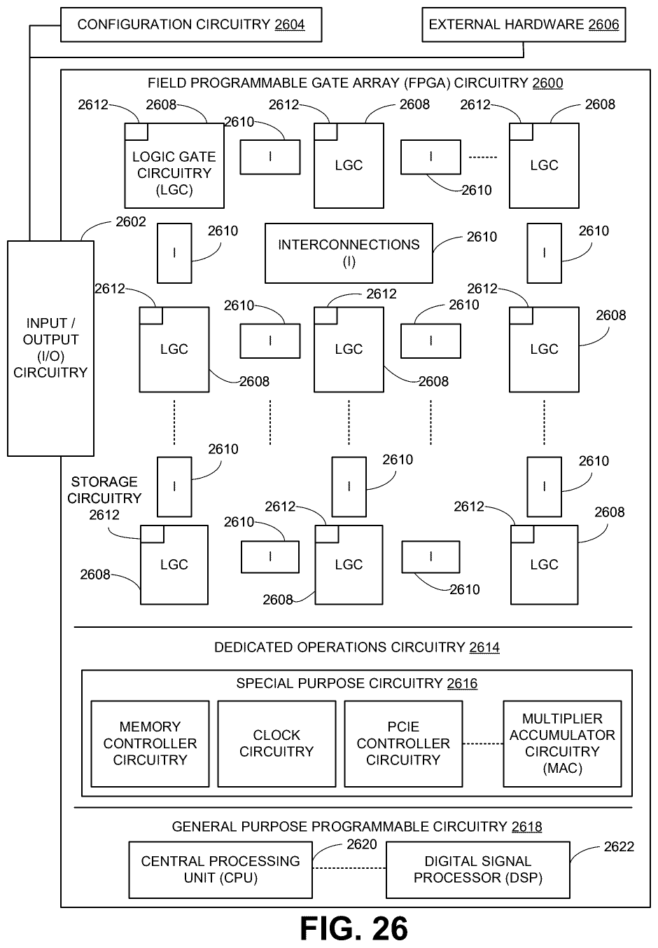

In some examples, the control circuitry 115 includes means for receiving user inputs. For example, the means for receiving may be implemented by the user input interface circuitry 2202. In some examples, the user input interface circuitry 2202 may be instantiated by programmable circuitry such as the example programmable circuitry 2412 of FIG. 24. For instance, the user input interface circuitry 2202 may be instantiated by the example microprocessor 2500 of FIG. 25 executing machine executable instructions such as those implemented by at least blocks 2304 of FIG. 23. In some examples, the user input interface circuitry 2202 may be instantiated by hardware logic circuitry, which may be implemented by an ASIC, XPU, or the FPGA circuitry 2600 of FIG. 26 configured and/or structured to perform operations corresponding to the machine readable instructions. Additionally or alternatively, the user input interface circuitry 2202 may be instantiated by any other combination of hardware, software, and/or firmware. For example, the user input interface circuitry 2202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 22, the example user output interface circuitry 2204 serves to enable the control circuitry 115 to provide and/or generate outputs to a user. In some examples, the user output interface circuitry 2204 is communicatively coupled to a screen (e.g., a touchscreen) on a housing of the control circuitry 115 to provide outputs to the user. Additionally or alternatively, in some examples, the user output interface circuitry 2204 is communicatively coupled to lights and/or other indicators (e.g., horns, bells, speakers, etc.) to provide notifications and/or other information to users. Additionally or alternatively, in some examples, the user output interface circuitry 2204 enables wireless communication with a remote device by which information and/or notifications are provided to a user. In some examples, the user output interface circuitry 2204 is instantiated by programmable circuitry executing user output interface instructions and/or configured to perform operations such as those represented by the flowchart(s) of FIG. 23.

In some examples, the control circuitry 115 includes means for providing and/or generating an output. For example, the means for providing may be implemented by the user output interface circuitry 2204. In some examples, the user output interface circuitry 2204 may be instantiated by programmable circuitry such as the example programmable circuitry 2412 of FIG. 24. In some examples, the user output interface circuitry 2204 may be instantiated by hardware logic circuitry, which may be implemented by an ASIC, XPU, or the FPGA circuitry 2600 of FIG. 26 configured and/or structured to perform operations corresponding to the machine readable instructions. Additionally or alternatively, the user output interface circuitry 2204 may be instantiated by any other combination of hardware, software, and/or firmware. For example, the user output interface circuitry 2204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 22, the example sensor interface circuitry 2206 enables communications with the one or more sensors 119 of the drive unit 114 to collect sensor feedback data relating to the operation and/or state of the drive unit 114. In some examples, the sensor interface circuitry 2206 provides collected sensor feedback data to the example memory 2214 for storage. In some examples, the sensor interface circuitry 2206 is instantiated by programmable circuitry executing sensor interface instructions and/or configured to perform operations such as those represented by the flowchart(s) of FIG. 23.

In some examples, the control circuitry 115 includes means for receiving sensor feedback data. For example, the means for receiving may be implemented by the example sensor interface circuitry 2206. In some examples, the example sensor interface circuitry 2206 may be instantiated by programmable circuitry such as the example programmable circuitry 2412 of FIG. 24. For instance, the example sensor interface circuitry 2206 may be instantiated by the example microprocessor 2500 of FIG. 25 executing machine executable instructions such as those implemented by at least blocks 2304, 2306, 2316 of FIG. 23. In some examples, the example sensor interface circuitry 2206 may be instantiated by hardware logic circuitry, which may be implemented by an ASIC, XPU, or the FPGA circuitry 2600 of FIG. 26 configured and/or structured to perform operations corresponding to the machine readable instructions. Additionally or alternatively, the example sensor interface circuitry 2206 may be instantiated by any other combination of hardware, software, and/or firmware. For example, the example sensor interface circuitry 2206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 22, the example sensor data analysis circuitry 2208 analyzes the sensor feedback data obtained from the sensors 119 (e.g., via the sensor interface circuitry 2206). More particularly, in some examples, the sensor data analysis circuitry 2208 monitors timing and/or position information associated with opening and/or closing operations of the door systems 100, 300 to identify different zones of operation. In some examples, the sensor data analysis circuitry 2208 monitors and/or collects torque data of the drive unit 114 while the door panels 102, 104, 302 are moving through the different zones of operation. In some examples, the sensor data analysis circuitry 2208 identifies, determines, and/or detects a peak value of the torque during different ones of the different zones of operations. In some examples, such peak torque values are detected at the time of installation of the door system 100, 300 to determine expected peak torque values during normal operations. In some examples, these peak torque values are used to set threshold values or limits for the torque during subsequent use of the door system 100, 300 to detect faults and/or potential issues in the operation of the door system 100, 300 (e.g., an object blocking movement of the door panels 102, 104, 302 to trigger a reversal in the direction of movement).

Analyzing the torque of the drive unit 114 in different zones can account for different operating circumstances associated with different portions of a door cycle (e.g., moving from a closed position to an open position or moving from an open position to a closed position). For instance, the torque typically spikes during at the beginning of a door cycle when the door panels 102, 104, 302 begin to move and are ramped up to full speed because the drive unit 114 needs to overcome the inertia of the resting door panels 102, 104, 302. Once the door panels 102, 104, 302 begin to move, less torque is needed to continue to move the door panels 102, 104, 302 through the rest of the door cycle. Accordingly, in some examples, the sensor data analysis circuitry 2208 identifies at least two zones of operation including (1) during the first moments of a door cycle and (2) after the door panels 102, 104, 302 have been ramped up to speed. In some examples, there may be additional zones of operation defined (e.g., when the door is being decelerated to stop, when the door reverses direction due to a detected fault, and/or at any other suitable time). Further, in some examples, separate zones of operation are defined for closing operations and opening operations. In other examples, both closing and opening cycles are defined with the same zones of operation. Existing door panels typically only define a single torque threshold that applies throughout the door cycle and, therefore, cannot account for the different circumstances associated with the different zones of operations.

In some examples, the zones of operation are based on different periods of time during a door cycle. For instance, in some examples, a first zone of operation is associated with a first period of time when a door panel 102, 104, 302 begins to move from a resting position and ramps up to full speed (e.g., begins to open from a closed position, or begins to close from an open position). In some examples, this first period of time is relatively short and can be less than one second in duration (e.g., 750 milliseconds or less, 500 milliseconds or less, 300 milliseconds or less, etc.). In some examples, a second zone of operation corresponds to the remainder of the time it takes to complete the door cycle. In such examples, the second period of time corresponding to the second zone of operation is longer than the first period of time (e.g., at least twice as long, at least five times as long, etc.). In some examples, the door cycle can be broken in three or more different time periods corresponding to three or more different zones of operations. Additionally or alternatively, in some examples, the zones of operation are based on the position of the door panels 102, 104, 302 during a door cycle (as measured by a position sensor in the drive unit 114). For instance, in some examples, the first zone of operation may correspond to a relatively short distance from a resting position (e.g., a fully open position or a fully closed position of the door) of the door panels 102, 104, 302. For instance, in some examples, the first zone of operation corresponds to when the door is within 1 foot of a beginning position. In other examples, the zone of operation can be defined based on any other suitable distance from the beginning position (e.g., within 2 feet, within 16 inches, within 8 inches, within 6 inches, within 2 inches, etc.). In some examples, a second zone of operation is defined to include any other position of the door panel outside of the first zone of operation. In other examples, the total travel path of the door panels 102, 104, 302 is divided into three or more portions corresponding to three or more zones of operation. In some examples, the sensor data analysis circuitry 2208 is instantiated by programmable circuitry executing sensor data analysis instructions and/or configured to perform operations such as those represented by the flowchart(s) of FIG. 23.

In some examples, the control circuitry 115 includes means for analyzing sensor data. For example, the means for analyzing may be implemented by the sensor data analysis circuitry 2208. In some examples, the sensor data analysis circuitry 2208 may be instantiated by programmable circuitry such as the example programmable circuitry 2412 of FIG. 24. For instance, the sensor data analysis circuitry 2208 may be instantiated by the example microprocessor 2500 of FIG. 25 executing machine executable instructions such as those implemented by at least blocks 2304, 2306, 2308, 2310, 2312, 2314, 2316, 2318, 2320 of FIG. 23. In some examples, the sensor data analysis circuitry 2208 may be instantiated by hardware logic circuitry, which may be implemented by an ASIC, XPU, or the FPGA circuitry 2600 of FIG. 26 configured and/or structured to perform operations corresponding to the machine readable instructions. Additionally or alternatively, the sensor data analysis circuitry 2208 may be instantiated by any other combination of hardware, software, and/or firmware. For example, the sensor data analysis circuitry 2208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 22, the example threshold determination circuitry 2210 determines torque thresholds for the different zones of operation based on the peak torque values detected while the drive unit 114 is moving the door panels 102, 104, 302 through the respective zones of operation. In some examples, the torque thresholds are calculated by multiplying the detected peak torque values by a multiplier. In some examples, the multipliers are any suitable values equal to or greater than 1 (e.g., 1.05, 1.1, 1.15, 1.25, 1.5, 2, etc.). In some examples, the multipliers are defined as some percentage (e.g., 0-100% or more) greater than a baseline (e.g., normalized to 1) so that the resulting torque threshold is greater than the peak torque value detected by the specified percentage. In some example, different multipliers are used for different zones of operation. In some examples, the same multiplier can be used for multiple torque thresholds associated with different ones of the zone of operation. In some examples, different multipliers are used for the zones of operation in an opening cycle as compared with the multipliers used for the zones of operations in a closing cycle. In some examples, the multipliers are defined based on the type of door. For instance, in some examples, a multi-panel door system (e.g., the door system of FIGS. 1 and 2) may have multipliers that are different from multipliers defined for a single panel door system (e.g., the door system of FIGS. 3 and 4). In some examples, the multipliers correspond to default values defined by the door system manufacture. In such examples, the multipliers may be stored in the example memory 2214. In some examples, the multipliers are user configurable such that the multipliers stored in the memory 2214 are updated based on user input. In some examples, the threshold determination circuitry 2210 is instantiated by programmable circuitry executing threshold determination instructions and/or configured to perform operations such as those represented by the flowchart(s) of FIG. 23.

In some examples, the control circuitry 115 includes means for determining thresholds. For example, the means for determining may be implemented by the example threshold determination circuitry 2210. In some examples, the example threshold determination circuitry 2210 may be instantiated by programmable circuitry such as the example programmable circuitry 2412 of FIG. 24. For instance, the example threshold determination circuitry 2210 may be instantiated by the example microprocessor 2500 of FIG. 25 executing machine executable instructions such as those implemented by at least blocks 2322, 2324, 2326 of FIG. 23. In some examples, the example threshold determination circuitry 2210 may be instantiated by hardware logic circuitry, which may be implemented by an ASIC, XPU, or the FPGA circuitry 2600 of FIG. 26 configured and/or structured to perform operations corresponding to the machine readable instructions. Additionally or alternatively, the example threshold determination circuitry 2210 may be instantiated by any other combination of hardware, software, and/or firmware. For example, the example threshold determination circuitry 2210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 22, the example drive unit control circuitry 2212 communicates with and/or controls operations of the drive unit 114. For examples, the drive unit control circuitry 2212 causes the drive unit 114 to activate and move the door panels 102, 104, 302 between the open and closed positions. In some examples, the operations implemented by the example drive unit control circuitry 2212 are based on sensor feedback data (e.g., obtained via the sensor interface circuitry), outputs of the sensor data analysis circuitry 2208, and/or the thresholds calculated by the threshold determination circuitry 2210. For instance, during normal operation the sensor data analysis circuitry 2208 may monitor the torque generated by the drive unit and compare the detected torque to the torque thresholds previously calculated by the threshold determination circuitry 2210 and stored in the memory 2214. If a detected torque value satisfies (e.g., exceeds) the threshold associated with the relevant zone of operation, the drive unit control circuitry 2212 may cause the drive unit 114 to stop and/or reverse the movement of the door panels 102, 104, 302. In some examples, the drive unit control circuitry 2212 is instantiated by programmable circuitry executing drive unit control instructions and/or configured to perform operations such as those represented by the flowchart(s) of FIG. 23.

In some examples, the control circuitry 115 includes means for causing the door panels 102, 104, 302 to move. For example, the means for causing the door panels 102, 104, 302 to move may be implemented by the example drive unit control circuitry 2212. In some examples, the example drive unit control circuitry 2212 may be instantiated by programmable circuitry such as the example programmable circuitry 2412 of FIG. 24. For instance, the example drive unit control circuitry 2212 may be instantiated by the example microprocessor 2500 of FIG. 25 executing machine executable instructions such as those implemented by at least blocks 2302, 2306, 2314, 2316 of FIG. 23. In some examples, the example drive unit control circuitry 2212 may be instantiated by hardware logic circuitry, which may be implemented by an ASIC, XPU, or the FPGA circuitry 2600 of FIG. 26 configured and/or structured to perform operations corresponding to the machine readable instructions. Additionally or alternatively, the example drive unit control circuitry 2212 may be instantiated by any other combination of hardware, software, and/or firmware. For example, the example drive unit control circuitry 2212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 22, the example memory 2214 stores information and/or data generated and/or used by the other components of the control circuitry 115. For instance, in some examples, the memory 2214 stored the sensor feedback data obtained from the sensor interface circuitry 2206 and/or outputs of the sensor data analysis circuitry 2208 analyzing the sensor feedback data (e.g., the peak torque values). Further, in some examples, the memory 2214 stores the torque thresholds calculated by the threshold determination circuitry 2210 as well as the multipliers used to calculate the thresholds. In some examples, the memory 2214 is instantiated by programmable circuitry executing memory instructions and/or configured to perform operations such as those represented by the flowchart(s) of FIG. 23.

In some examples, the control circuitry 115 includes means for storing. For example, the means for storing may be implemented by the example memory 2214. In some examples, the example memory 2214 may be instantiated by programmable circuitry such as the example programmable circuitry 2412 of FIG. 24. For instance, the example memory 2214 may be instantiated by the example microprocessor 2500 of FIG. 25 executing machine executable instructions such as those implemented by at least blocks 2304, 2306, 2308, 2316, 2322 of FIG. 23. In some examples, the example memory 2214 may be instantiated by hardware logic circuitry, which may be implemented by an ASIC, XPU, or the FPGA circuitry 2600 of FIG. 26 configured and/or structured to perform operations corresponding to the machine readable instructions. Additionally or alternatively, the example memory 2214 may be instantiated by any other combination of hardware, software, and/or firmware. For example, the example memory 2214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the control circuitry 115 of FIG. 1 is illustrated in FIG. 22, one or more of the elements, processes, and/or devices illustrated in FIG. 22 may be combined, divided, re-arranged, omitted, eliminated, and/or implemented in any other way. Further, the example user input interface circuitry 2202, the example user output interface circuitry 2204, the example sensor interface circuitry 2206, the example sensor data analysis circuitry 2208, the example threshold determination circuitry 2210, the example drive unit control circuitry 2212, the example memory 2214, and/or, more generally, the example control circuitry 115 of FIG. 22, may be implemented by hardware alone or by hardware in combination with software and/or firmware. Thus, for example, any of the example user input interface circuitry 2202, the example user output interface circuitry 2204, the example sensor interface circuitry 2206, the example sensor data analysis circuitry 2208, the example threshold determination circuitry 2210, the example drive unit control circuitry 2212, the example memory 2214, and/or, more generally, the example control circuitry 115, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s)

(FPLD(s)) such as FPGAs. Further still, the example control circuitry 115 of FIG. 22 may include one or more elements, processes, and/or devices in addition to, or instead of, those illustrated in FIG. 22, and/or may include more than one of any or all of the illustrated elements, processes and devices.

Flowchart(s) representative of example machine readable instructions, which may be executed by programmable circuitry to implement and/or instantiate the control circuitry 115 of FIG. 22 and/or representative of example operations which may be performed by programmable circuitry to implement and/or instantiate the control circuitry 115 of FIG. 22, are shown in FIG. 23. The machine readable instructions may be one or more executable programs or portion(s) of one or more executable programs for execution by programmable circuitry such as the programmable circuitry 2412 shown in the example processor platform 2400 discussed below in connection with FIG. 24 and/or may be one or more function(s) or portion(s) of functions to be performed by the example programmable circuitry (e.g., an FPGA) discussed below in connection with FIGS. 25 and/or 26. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 23, many other methods of implementing the example control circuitry 115 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 23 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 23 is a flowchart representative of example machine readable instructions and/or example operations 2300 that may be executed, instantiated, and/or performed by programmable circuitry to calibrate a door system (e.g., either of the door systems 100, 300 of FIGS. 1-4). Typically, the example operations 2300 are implemented at the time a door system is installed. However, the example operations 2300 can be implemented at any suitable time (e.g., periodically to account for wear and tear, when the door panels are replaced, etc.). The example machine-readable instructions and/or the example operations 2300 of FIG. 23 begin at block 2302, where the example drive unit control circuitry 2212 causes the door panel(s) 102, 104, 302 to move to a fully closed position (e.g., as shown in FIGS. 1 and 3). At block 2304, the example sensor data analysis circuitry 2208 collects position data corresponding to the fully closed position. In some examples, the position data is based on sensor feedback data from a position sensor (e.g., one of the sensors 119 in FIGS. 1-4) obtained via the example sensor interface circuitry 2206. In some examples, the sensor data analysis circuitry 2208 provides the position data (e.g., closed position information) to the example memory 2214 for storage.

At block 2306, the example sensor data analysis circuitry 2208 collects torque data while the drive unit control circuitry 2212 causes the door panel(s) 102, 104, 302 to move to the fully open position. In some examples, the torque data is based on sensor feedback data from a torque sensor (e.g., one of the sensors 119 in FIGS. 1-4) obtained via the example sensor interface circuitry 2206. In some examples, the sensor data analysis circuitry 2208 provides the torque data to the example memory 2214 (or a memory controller) for storage. At block 2308, the example sensor data analysis circuitry 2208 collects position data corresponding to the fully open position. In some examples, the sensor data analysis circuitry 2208 provides the position data (e.g., open position information) to the example memory 2214 for storage. In this example, the operations 2300 begins by moving the door panel(s) 102, 104, 302 to the closed position and then moving the panel(s) to the open position. However, in other examples, the operation may be reversed by first moving the door panel(s) 102, 104, 302 to the open position and then moving the panel(s) to the closed position. In some examples, the open and closed position information defined by the collected position data (collected at block 2304 and 2308) is stored in the example memory 2214 as travel limits for the door panel(s) 102, 104, 302 defining the full range or distance the door panel(s) 102, 104, 302 are capable of moving. In some examples, the collection of the position data to define the travel limits of the door panel(s) 102, 104, 302 (e.g., blocks 2304 and 2308) may be omitted from the example operations 2300. That is, in some examples, calibration of travel limits and calibration of torque limits may be done at different times and/or in separate processes.

At block 2310, the example sensor data analysis circuitry 2208 separates the torque data into different zones associated with different door positions and/or different times during an opening cycle. In this example, block 2310 refers to an opening cycle because the process begins with the door in the closed position (block 2302) and moves to the open position (block 2306). However, in examples, where the process is reversed, the example sensor data analysis circuitry 2208 separates the torque data associated with different door positions during a closing cycle. In some examples, the different zones are defined by different positions of the door panel(s) 102, 104, 302 along their travel path (e.g., defined by the travel limits determined based on the position data collected at blocks 2304, 2306). Additionally or alternatively, in some examples, the different zones are defined based on different periods of time counted from when the opening (or closing) cycle begins. In some examples, at least two zones of operation are defined for the opening (or closing) cycle including an acceleration, start-up, or ramp-up zone of operation associated with the very beginning of the cycle when the door panel(s) 102, 104, 302 begin to move and ramp up speed. In some examples, a second zone of operation corresponds to the rest of the door cycle. In other examples, separate zones of operation may be defined to include a steady state zone of operation and a deceleration or stopping zone of operation. In such examples, the deceleration or stopping zone of operation corresponds to when the door panel(s) begins to slow down and then stops at the end of the cycle and the steady state zone of operation is between the first and last zones of operation. In other examples, any suitable number of zones of operation may be defined in any suitable manner.

Having separated the torque data into the different zones of operation (block 2312), control advances to block 2312. At block 2312, the example sensor data analysis circuitry 2208 identifies a peak torque value in each zone of operation. When this process is performed at the time of installation, the peak torque values are indicative of typical values expected for normal operation of the door system 100, 300. Accordingly, in some examples, these peak torque values are used to define torque thresholds used to detect potential issues (e.g., damage and/or wear to equipment, objects obstructing movement of the door panel(s) 102, 104, 302, etc.) that may arise during subsequent use of the door system 100, 300. In some examples, the same thresholds may be used regardless of whether the door panel(s) 102, 104, 302 are being opened or closed. However, in other examples, different thresholds may be defined for the different directions of door movement. Accordingly, at block 2314, the control circuitry 115 (e.g., via the sensor data analysis circuitry 2208 and/or the drive unit control circuitry 2212) determines whether the same thresholds are to be used for both the opening and closing cycles. If not, control advances to block 2316. Blocks 2316, 2318, and 2320 are similar to respective blocks 2306, 2310, 2312 described above except that blocks 2316, 2318, and 2320 are associated with a closing cycle rather than an opening cycle. Thus, the description of blocks 2306, 2310, 2312 apply similarly to blocks 2316, 2318, and 2320. After the completion of blocks 2316, 2318, and 2320, control advances to block 2322. Returning to block 2314, if is determined that the same thresholds are to be used for both opening and closing cycles, control advances directly to block 2322.

At block 2322, the example threshold determination circuitry 2210 calculates a torque threshold for each zone of operation based on the corresponding peak torque value and an associated multiplier. In some examples, the multipliers for the different zones of operation are defined by an original equipment manufacturer and retrieved from the example memory 2214. In some examples, the same multiplier is used for multiple different zones of operations. In some examples, different multipliers are used for the different zones of operations. At block 2324, the example threshold determination circuitry 2210 determines whether different multiplier(s) are specified by a user. That is, in some examples, the multipliers are user-configurable such that a user can modify the manufacturer-set (e.g., default) multipliers. If a user has specified different multiplier(s) (e.g., based on a user input obtained via the example user input interface circuitry 2202), control advances to block 2326 where the threshold determination circuitry 2210 updates the torque threshold(s) associated with the use-specified multiplier(s). In some examples, a user may specify the multiplier(s) prior to the implementation of the operations 2300 of FIG. 23. In such examples, the initial calculation of the thresholds (at block 2322) is based on the user-specified values and blocks 2324 and 2326 may be omitted. Thereafter, control advances to block 2328. If, at block 2324, the example threshold determination circuitry 2210 determines that no different multiplier(s) have been specified by a user, control advances directly to block 2328. At block 2328, the example memory stores the torque thresholds. Thereafter, the example operations 2300 of FIG. 23 ends.

FIG. 24 is a block diagram of an example programmable circuitry platform 2400 structured to execute and/or instantiate the example machine-readable instructions and/or the example operations of FIG. 23 to implement the control circuitry 115 of FIG. 22. The programmable circuitry platform 2400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 2400 of the illustrated example includes programmable circuitry 2412. The programmable circuitry 2412 of the illustrated example is hardware. For example, the programmable circuitry 2412 can be implemented by one or more integrated circuits, logic circuits, FPGAs, microprocessors, CPUs, GPUs, VPUs, DSPs, and/or microcontrollers from any desired family or manufacturer. The programmable circuitry 2412 may be implemented by one or more semiconductor based (e.g., silicon based) devices. In this example, the programmable circuitry 2412 implements example user input interface circuitry 2202, the example user output interface circuitry 2204, the example sensor interface circuitry 2206, the example sensor data analysis circuitry 2208, the example threshold determination circuitry 2210, and the example drive unit control circuitry 2212.

The programmable circuitry 2412 of the illustrated example includes a local memory 2413 (e.g., a cache, registers, etc.). The programmable circuitry 2412 of the illustrated example is in communication with main memory 2414, 2416, which includes a volatile memory 2414 and a non-volatile memory 2416, by a bus 2418. The volatile memory 2414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2416 may be implemented by flash memory and/or any other desired type of memory device. Access to the main memory 2414, 2416 of the illustrated example is controlled by a memory controller 2417. In some examples, the memory controller 2417 may be implemented by one or more integrated circuits, logic circuits, microcontrollers from any desired family or manufacturer, or any other type of circuitry to manage the flow of data going to and from the main memory 2414, 2416.

The programmable circuitry platform 2400 of the illustrated example also includes interface circuitry 2420. The interface circuitry 2420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2422 are connected to the interface circuitry 2420. The input device(s) 2422 permit(s) a user (e.g., a human user, a machine user, etc.) to enter data and/or commands into the programmable circuitry 2412. The input device(s) 2422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 2424 are also connected to the interface circuitry 2420 of the illustrated example. The output device(s) 2424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2420 of the illustrated example, thus, typically includes a graphics driver card, a graphics driver chip, and/or graphics processor circuitry such as a GPU.

The interface circuitry 2420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 2400 of the illustrated example also includes one or more mass storage discs or devices 2428 to store firmware, software, and/or data. Examples of such mass storage discs or devices 2428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 2432, which may be implemented by the machine readable instructions of FIG. 23, may be stored in the mass storage device 2428, in the volatile memory 2414, in the non-volatile memory 2416, and/or on at least one non-transitory computer readable storage medium such as a CD or DVD which may be removable.

FIG. 25 is a block diagram of an example implementation of the programmable circuitry 2412 of FIG. 24. In this example, the programmable circuitry 2412 of FIG. 24 is implemented by a microprocessor 2500. For example, the microprocessor 2500 may be a general-purpose microprocessor (e.g., general-purpose microprocessor circuitry). The microprocessor 2500 executes some or all of the machine-readable instructions of the flowchart of FIG. 23 to effectively instantiate the circuitry of FIG. 22 as logic circuits to perform operations corresponding to those machine readable instructions. In some such examples, the circuitry of FIG. 22 is instantiated by the hardware circuits of the microprocessor 2500 in combination with the machine-readable instructions. For example, the microprocessor 2500 may be implemented by multi-core hardware circuitry such as a CPU, a DSP, a GPU, an XPU, etc. Although it may include any number of example cores 2502 (e.g., 1 core), the microprocessor 2500 of this example is a multi-core semiconductor device including N cores. The cores 2502 of the microprocessor 2500 may operate independently or may cooperate to execute machine readable instructions. For example, machine code corresponding to a firmware program, an embedded software program, or a software program may be executed by one of the cores 2502 or may be executed by multiple ones of the cores 2502 at the same or different times. In some examples, the machine code corresponding to the firmware program, the embedded software program, or the software program is split into threads and executed in parallel by two or more of the cores 2502. The software program may correspond to a portion or all of the machine readable instructions and/or operations represented by the flowchart of FIG. 23.

The cores 2502 may communicate by a first example bus 2504. In some examples, the first bus 2504 may be implemented by a communication bus to effectuate communication associated with one(s) of the cores 2502. For example, the first bus 2504 may be implemented by at least one of an Inter-Integrated Circuit (I2C) bus, a Serial Peripheral Interface (SPI) bus, a PCI bus, or a PCle bus. Additionally or alternatively, the first bus 2504 may be implemented by any other type of computing or electrical bus. The cores 2502 may obtain data, instructions, and/or signals from one or more external devices by example interface circuitry 2506. The cores 2502 may output data, instructions, and/or signals to the one or more external devices by the interface circuitry 2506. Although the cores 2502 of this example include example local memory 2520 (e.g., Level 1 (L1) cache that may be split into an L1 data cache and an L1 instruction cache), the microprocessor 2500 also includes example shared memory 2510 that may be shared by the cores (e.g., Level 2 (L2 cache)) for high-speed access to data and/or instructions. Data and/or instructions may be transferred (e.g., shared) by writing to and/or reading from the shared memory 2510. The local memory 2520 of each of the cores 2502 and the shared memory 2510 may be part of a hierarchy of storage devices including multiple levels of cache memory and the main memory (e.g., the main memory 2414, 2416 of FIG. 24). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2502 may be referred to as a CPU, DSP, GPU, etc., or any other type of hardware circuitry. Each core 2502 includes control unit circuitry 2514, arithmetic and logic (AL) circuitry (sometimes referred to as an ALU) 2516, a plurality of registers 2518, the local memory 2520, and a second example bus 2522. Other structures may be present. For example, each core 2502 may include vector unit circuitry, single instruction multiple data (SIMD) unit circuitry, load/store unit (LSU) circuitry, branch/jump unit circuitry, floating-point unit (FPU) circuitry, etc. The control unit circuitry 2514 includes semiconductor-based circuits structured to control (e.g., coordinate) data movement within the corresponding core 2502. The AL circuitry 2516 includes semiconductor-based circuits structured to perform one or more mathematic and/or logic operations on the data within the corresponding core 2502. The AL circuitry 2516 of some examples performs integer based operations. In other examples, the AL circuitry 2516 also performs floating-point operations. In yet other examples, the AL circuitry 2516 may include first AL circuitry that performs integer-based operations and second AL circuitry that performs floating-point operations. In some examples, the AL circuitry 2516 may be referred to as an Arithmetic Logic Unit (ALU).

The registers 2518 are semiconductor-based structures to store data and/or instructions such as results of one or more of the operations performed by the AL circuitry 2516 of the corresponding core 2502. For example, the registers 2518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 2518 may be arranged in a bank as shown in FIG. 25. Alternatively, the registers 2518 may be organized in any other arrangement, format, or structure, such as by being distributed throughout the core 2502 to shorten access time. The second bus 2522 may be implemented by at least one of an I2C bus, a SPI bus, a PCI bus, or a PCle bus.

Each core 2502 and/or, more generally, the microprocessor 2500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2500 is a semiconductor device fabricated to include many transistors interconnected to implement the structures described above in one or more integrated circuits (ICs) contained in one or more packages.

The microprocessor 2500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 2500, in the same chip package as the microprocessor 2500 and/or in one or more separate packages from the microprocessor 2500.

FIG. 26 is a block diagram of another example implementation of the programmable circuitry 2412 of FIG. 24. In this example, the programmable circuitry 2412 is implemented by FPGA circuitry 2600. For example, the FPGA circuitry 2600 may be implemented by an FPGA. The FPGA circuitry 2600 can be used, for example, to perform operations that could otherwise be performed by the example microprocessor 2500 of FIG. 25 executing corresponding machine readable instructions. However, once configured, the FPGA circuitry 2600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 2500 of FIG. 25 described above (which is a general purpose device that may be programmed to execute some or all of the machine readable instructions represented by the flowchart(s) of FIG. 23 but whose interconnections and logic circuitry are fixed once fabricated), the FPGA circuitry 2600 of the example of FIG. 26 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 23. In particular, the FPGA circuitry 2600 may be thought of as an array of logic gates, interconnections, and switches. The switches can be programmed to change how the logic gates are interconnected by the interconnections, effectively forming one or more dedicated logic circuits (unless and until the FPGA circuitry 2600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 23. As such, the FPGA circuitry 2600 may be configured and/or structured to effectively instantiate some or all of the operations/functions corresponding to the machine readable instructions of the flowchart(s) of FIG. 23 as dedicated logic circuits to perform the operations/functions corresponding to those software instructions in a dedicated manner analogous to an ASIC. Therefore, the FPGA circuitry 2600 may perform the operations/functions corresponding to the some or all of the machine readable instructions of FIG. 23 faster than the general-purpose microprocessor can execute the same.

In the example of FIG. 26, the FPGA circuitry 2600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2600 of FIG. 26 may access and/or load the binary file to cause the FPGA circuitry 2600 of FIG. 26 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2600 of FIG. 26 to cause configuration and/or structuring of the FPGA circuitry 2600 of FIG. 26, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2600 of FIG. 26 may access and/or load the binary file to cause the FPGA circuitry 2600 of FIG. 26 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2600 of FIG. 26 to cause configuration and/or structuring of the FPGA circuitry 2600 of FIG. 26, or portion(s) thereof.

The FPGA circuitry 2600 of FIG. 26, includes example input/output (I/O) circuitry 2602 to obtain and/or output data to/from example configuration circuitry 2604 and/or external hardware 2606. For example, the configuration circuitry 2604 may be implemented by interface circuitry that may obtain a binary file, which may be implemented by a bit stream, data, and/or machine-readable instructions, to configure the FPGA circuitry 2600, or portion(s) thereof. In some such examples, the configuration circuitry 2604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2606 may be implemented by external hardware circuitry. For example, the external hardware 2606 may be implemented by the microprocessor 2500 of FIG. 25.

The FPGA circuitry 2600 also includes an array of example logic gate circuitry 2608, a plurality of example configurable interconnections 2610, and example storage circuitry 2612. The logic gate circuitry 2608 and the configurable interconnections 2610 are configurable to instantiate one or more operations/functions that may correspond to at least some of the machine readable instructions of FIG. 23 and/or other desired operations. The logic gate circuitry 2608 shown in FIG. 26 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2608 to enable configuration of the electrical structures and/or the logic gates to form circuits to perform desired operations/functions. The logic gate circuitry 2608 may include other electrical structures such as look-up tables (LUTs), registers (e.g., flip-flops or latches), multiplexers, etc.

The configurable interconnections 2610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2608 to program desired logic circuits.

The storage circuitry 2612 of the illustrated example is structured to store result(s) of the one or more of the operations performed by corresponding logic gates. The storage circuitry 2612 may be implemented by registers or the like. In the illustrated example, the storage circuitry 2612 is distributed amongst the logic gate circuitry 2608 to facilitate access and increase execution speed.

The example FPGA circuitry 2600 of FIG. 26 also includes example dedicated operations circuitry 2614. In this example, the dedicated operations circuitry 2614 includes special purpose circuitry 2616 that may be invoked to implement commonly used functions to avoid the need to program those functions in the field. Examples of such special purpose circuitry 2616 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 2600 may also include example general purpose programmable circuitry 2618 such as an example CPU 2620 and/or an example DSP 2622. Other general purpose programmable circuitry 2618 may additionally or alternatively be present such as a GPU, an XPU, etc., that can be programmed to perform other operations.

Although FIGS. 25 and 26 illustrate two example implementations of the programmable circuitry 2412 of FIG. 24, many other approaches are contemplated. For example, FPGA circuitry may include an on-board CPU, such as one or more of the example CPU 2620 of FIG. 25. Therefore, the programmable circuitry 2412 of FIG. 24 may additionally be implemented by combining at least the example microprocessor 2500 of FIG. 25 and the example FPGA circuitry 2600 of FIG. 26. In some such hybrid examples, one or more cores 2502 of FIG. 25 may execute a first portion of the machine readable instructions represented by the flowchart(s) of FIG. 23 to perform first operation(s)/function(s), the FPGA circuitry 2600 of FIG. 26 may be configured and/or structured to perform second operation(s)/function(s) corresponding to a second portion of the machine readable instructions represented by the flowcharts of FIG. 23, and/or an ASIC may be configured and/or structured to perform third operation(s)/function(s) corresponding to a third portion of the machine readable instructions represented by the flowcharts of FIG. 23.

It should be understood that some or all of the circuitry of FIG. 22 may, thus, be instantiated at the same or different times. For example, same and/or different portion(s) of the microprocessor 2500 of FIG. 25 may be programmed to execute portion(s) of machine-readable instructions at the same and/or different times. In some examples, same and/or different portion(s) of the FPGA circuitry 2600 of FIG. 26 may be configured and/or structured to perform operations/functions corresponding to portion(s) of machine-readable instructions at the same and/or different times.

In some examples, some or all of the circuitry of FIG. 22 may be instantiated, for example, in one or more threads executing concurrently and/or in series. For example, the microprocessor 2500 of FIG. 25 may execute machine readable instructions in one or more threads executing concurrently and/or in series. In some examples, the FPGA circuitry 2600 of FIG. 26 may be configured and/or structured to carry out operations/functions concurrently and/or in series. Moreover, in some examples, some or all of the circuitry of FIG. 22 may be implemented within one or more virtual machines and/or containers executing on the microprocessor 2500 of FIG. 25.

In some examples, the programmable circuitry 2412 of FIG. 24 may be in one or more packages. For example, the microprocessor 2500 of FIG. 25 and/or the FPGA circuitry 2600 of FIG. 26 may be in one or more packages. In some examples, an XPU may be implemented by the programmable circuitry 2412 of FIG. 24, which may be in one or more packages. For example, the XPU may include a CPU (e.g., the microprocessor 2500 of FIG. 25, the CPU 2620 of FIG. 26, etc.) in one package, a DSP (e.g., the DSP 2622 of FIG. 26) in another package, a GPU in yet another package, and an FPGA (e.g., the FPGA circuitry 2600 of FIG. 26) in still yet another package.

From the foregoing, it will be appreciated that example systems, apparatus, articles of manufacture, and methods have been disclosed that facilitate controlled adjustments to the position of door panels in both a vertical and horizontal (e.g., in and out) direction relative to a doorway to achieve reliable sealing engagement between seals on the door panels and the floor and/or walls or other structure surrounding the doorway while also enabling adjustments to such sealing engagement to account for tradeoffs relating to the resulting impact of wear on the seals. Further, examples disclosed herein enable the automatic calibration of thresholds for a torque generated by a drive unit used to move the door panels that accounts for different circumstances associated with different portions and/or time periods of opening and/or closing door cycles. Disclosed systems, apparatus, articles of manufacture, and methods are accordingly directed to one or more improvement(s) in the operation of a machine such as a computer or other electronic and/or mechanical device.

Further examples and combinations thereof include the following:
Example 1 includes an apparatus comprising a first plate including a slot through which a first threaded fastener is to connect to a door panel, a second plate to be between the first plate and a head of the first threaded fastener when the first threaded fastener is connected to the door panel, and a second threaded fastener to couple the first and second plates so that rotation of the second threaded fastener results in movement of the second plate and the connected door panel relative to the first plate.
Example 2 includes the apparatus of example 1, wherein the door panel is a horizontally translating door panel.
Example 3 includes the apparatus of example 2, wherein the movement of the second plate relative to the first plate is to be in a direction substantially perpendicular to a direction of travel of the translating door panel.
Example 4 includes the apparatus of any one of examples 1-3, further including a third plate coupled to the first plate, the third plate substantially perpendicular to the first plate, the door panel to be supported from a track via the third plate.
Example 5 includes the apparatus of example 4, wherein the second threaded fastener extends through the third plate.
Example 6 includes the apparatus of example 4, wherein the second threaded fastener extends through a flange extending from the first plate, the flange spaced apart from the second plate.
Example 7 includes the apparatus of any one of examples 1-6, wherein the second threaded fastener is to be connected to the second plate via an arm protruding from the second plate.
Example 8 includes the apparatus of any one of examples 1-6, wherein the second threaded fastener is to extend into a side edge of the second plate between first and second surfaces of the second plate, the first surface to face toward the first plate, the second surface to face toward the head of the first threaded fastener.
Example 9 includes the apparatus of any one of examples 1-8, wherein an axis of rotation of the second threaded fastener is substantially parallel to an elongate length of the slot.
Example 10 includes the apparatus of any one of examples 1-9, wherein the second threaded fastener is a set screw.
Example 11 includes the apparatus of any one of example 1-10, wherein the slot is a first slot, the first plate includes a second slot that extends substantially parallel to the first slot, and the second plate includes a protrusion that extends into the second slot.
Example 12 includes the apparatus of example 11, wherein the protrusion is a third threaded fastener.
Example 13 includes the apparatus of any one of examples 11 or 12, wherein the protrusion protrudes away from the second plate by a distance that is less than a thickness of the first plate.
Example 14 includes an apparatus, comprising an anchor plate to be positioned on a floor adjacent to a doorway, the anchor plate including a flange, the flange to protrude away from the floor, a retention block to be coupled to the flange, and a shim selectively positionable on either a first side of the flange or a second side of the flange opposite the first side, the retention block to be in a first position when the shim is on the first side of the flange, the retention block to be in a second position when the shim is on the first side of the flange, the first position closer to the doorway than the second position is to the doorway.
Example 15 includes the apparatus of example 14, wherein the retention block includes a cavity, both the flange and the shim to fit within the cavity.
Example 16 includes the apparatus of example 15, further include a threaded fastener, and a nut connected to the fastener, the threaded fastener to extend through a wall of the cavity and to extend through both the flange and the shim.
Example 17 includes the apparatus of example 16, wherein the threaded fastener is to extend through a slot in the flange, the slot open at an edge of the flange to enable the fastener to be removed from the flange without removing the nut from the threaded fastener.
Example 18 includes the apparatus of any one of examples 14-17, wherein the shim is a first shim of a plurality of shims, different ones of the plurality of shims selectively positionable on either the first side of the flange or a second side of the flange.
Example 19 includes the apparatus of example 18, further including a pin to extend through the plurality of shims.
Example 20 includes the apparatus of example 19, wherein the pin is to extend into an opening in the retention block.
Example 21 includes the apparatus of any one of examples 19 or 20, further including a brace to support the pin.
Example 22 includes the apparatus of any one of examples 14-21, wherein the retention block has a length, a width, and a height, the length greater than the width.
Example 23 includes the apparatus of example 22, wherein the width enables the retention block to fit within a channel in a bottom rail of a horizontally translating door panel, and the height enables the retention block to engage sidewalls of the channel.
Example 24 includes the apparatus of any one of examples 14-23, wherein the anchor plate includes a back plate and a bottom plate, and the retention block includes a recess that fits over the bottom plate.
Example 25 includes the apparatus of any one of examples 14-24, wherein the retention block includes angled surfaces such that an end of an elongate length of the retention block is narrower than a midsection of the elongate length of the retention block.
Example 26 includes an apparatus interface circuitry, machine readable instructions, and programmable circuitry to at least one of instantiate or execute the machine readable instructions to collect torque data from a sensor monitoring a door panel moving through at least one of an opening cycle or a closing cycle, identify peak torque values during different zones of operation associated with the at least one of the opening cycle or the closing cycle, and determine different torque thresholds for the different zones of operation based on respective ones of the peak torque values.
Example 27 includes the apparatus of example 26, wherein the zones of operation include a ramp-up zone of operation, the ramp-up zone associated with a beginning portion of the at least one of the opening cycle or the closing cycle when the door panel begins moving.
Example 28 includes the apparatus of example 27, wherein the zones of operation include at least one of a steady state zone of operation or a stopping zone of operation.
Example 29 includes the apparatus of any one of examples 26-28, wherein the programmable circuitry is to collect the torque data during both the opening cycle and the closing cycle, the different torque thresholds including a first set of thresholds associated with the opening cycle and a second set of thresholds associated with the closing cycle, the first set of thresholds different than the second set of thresholds.
Example 30 includes the apparatus of any one of examples 26-29, wherein a same one of the torque thresholds is used for a first zone of operation associated with the opening cycle and for a second zone of operation associated with the closing cycle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a first plate including a slot through which a first threaded fastener is to connect to a door panel;
a second plate to be between the first plate and a head of the first threaded fastener when the first threaded fastener is connected to the door panel; and
a second threaded fastener to couple the first and second plates so that rotation of the second threaded fastener results in movement of the second plate and the connected door panel relative to the first plate.

2. The apparatus of claim 1, wherein the door panel is a horizontally translating door panel.

3. The apparatus of claim 2, wherein the movement of the second plate relative to the first plate is to be in a direction substantially perpendicular to a direction of travel of the translating door panel.

4. The apparatus of claim 1, further including a third plate coupled to the first plate, the third plate substantially perpendicular to the first plate, the door panel to be supported from a track via the third plate.

5. The apparatus of claim 4, wherein the second threaded fastener extends through the third plate.

6. The apparatus of claim 4, wherein the second threaded fastener extends through a flange extending from the first plate, the flange spaced apart from the second plate.

7. The apparatus of claim 1, wherein the second threaded fastener is to be connected to the second plate via an arm protruding from the second plate.

8. The apparatus of claim 1, wherein the second threaded fastener is to extend into a side edge of the second plate between first and second surfaces of the second plate, the first surface to face toward the first plate, the second surface to face toward the head of the first threaded fastener.

9. The apparatus of claim 1, wherein an axis of rotation of the second threaded fastener is substantially parallel to an elongate length of the slot.

10. The apparatus of claim 1, wherein the second threaded fastener is a set screw.

11. The apparatus of claim 1, wherein the slot is a first slot, the first plate includes a second slot that extends substantially parallel to the first slot, and the second plate includes a protrusion that extends into the second slot.

12. The apparatus of claim 11, wherein the protrusion is a third threaded fastener.

13. The apparatus of claim 11, wherein the protrusion protrudes away from the second plate by a distance that is less than a thickness of the first plate.

14. The apparatus of claim 1, further including:
an anchor plate to be positioned on a floor, the anchor plate to extend underneath the door panel;
a retention block to be coupled to the anchor plate, the retention block to; and
a shim to adjust a position of the retention block relative to the anchor plate in a direction transverse to a travel path of the door panel.

15. The apparatus of claim 1, further including a controller to:
collect torque data from a sensor monitoring movement of the door panel; and
determine, based on the torque data, different torque thresholds for different zones of operation associated with at least one of an opening cycle of the door panel or a closing cycle of the door panel.

16. An apparatus comprising:
a plate to be held adjacent a top edge of a door panel;
a bracket to be held adjacent the plate, the plate between the bracket and the top edge of the door panel, the bracket to be fastened to the door panel so that the bracket and the door panel are capable of moving in unison relative to the plate; and
a threaded fastener to extend through at least a portion of the bracket, rotation of the threaded fastener to slidably adjust a position of both the bracket and the door panel relative to the plate.

17. The apparatus of claim 16, wherein the fastener is a first fastener, and the bracket is to be fastened to the door panel by a second fastener extending through a slot in the plate.

18. The apparatus of claim 16, wherein the plate is a first plate, the apparatus further including a second plate to be coupled and extending transverse to the first plate, the threaded fastener to extend through the second plate.

19. The apparatus of claim 16, wherein the rotation of the threaded fastener is to cause the position of both the bracket and the door panel to be adjusted in a direction substantially perpendicular to a face of the door panel.

20. An apparatus comprising:
a track coupling assembly to be coupled to a track adjacent a doorway;
a panel coupling assembly to be coupled to a top of a door panel, the door panel to selectively block and unblock the doorway;
a first threaded fastener to couple the panel coupling assembly to the track coupling assembly, rotation of the first threaded fastener to adjust a height of the door panel; and
a second threaded fastener including in the panel coupling assembly, rotation of the second threaded fastener to adjust a distance of the door panel from the doorway.

21.-37. (canceled)
